(19) United States
(12) Patent Application Publication
(10) Pub. No.: US 2024/0149212 A1
(43) Pub. Date: May 9, 2024

(54) GAS CAPTURE SYSTEM

(71) Applicant: KING ABDULLAH UNIVERSITY OF SCIENCE AND TECHNOLOGY, Thuwal (SA)

(72) Inventors: Deoras Mukund Prabhudharwadkar, Thuwal (SA); William Lafayette Roberts, Thuwal (SA); Christopher Brian Wagstaff, Thuwal (SA)

(21) Appl. No.: 18/280,303

(22) PCT Filed: Mar. 4, 2022
(86) PCT No.: PCT/IB22/51913

§ 371 Date: Sep. 5, 2023

Related U.S. Application Data
(60) Provisional application No. 63/156,987, filed on Mar. 5, 2021.

(51) Int. Cl. B01D 53/18; B01D 7/02; B01D 53/00; B01D 53/14; F23J 15/04

(52) U.S. Cl. CPC B01D 53/18; B01D 7/02; B01D 53/002; B01D 53/1475; F23J 15/04; B01D 2257/504; B01D 2258/0283; F23J 2215/50; F23J 2219/40

(57) ABSTRACT

A wetted-wire liquid-gas contactor device is disclosed comprising a plurality of wires, a first support structure configured to retain the plurality of wires, and a liquid distribution system for receiving and distributing a liquid to the plurality of wires. The diameter of the plurality of wires is approximately 2 mm or less, wherein a pitch of the plurality of wires is less than 4.0 mm.

### BACKGROUND

### Field of the Invention

The present disclosure relates generally to a device for energy and mass recovery from exhaust streams of large pollutant sources. More particularly, the present disclosure relates generally to column internals and/or devices for gas and liquid contacting not limited by application.

### Background of the Invention

Industrial facilities, power plants, or another sources produce flue gas such as those emitted in exhaust streams from the burning of fossil fuels. Techniques have been developed for capturing species, however, they are often inefficient. Thus, there is a need to provide more efficient techniques and designs for capturing species in exhaust streams and treating the same. In addition, there is a further need to provide a more efficient gas-liquid contactor which is smaller, uses less contact liquid (or absorbant), and/or requires less gas-side blowing power.

### SUMMARY

According to first broad aspect, the present disclosure provides a wetted-wire liquid-gas contactor device comprising: a plurality of wires; a first support structure configured to retain the plurality of wires; and a liquid distribution system for receiving and distributing a liquid to the plurality of wires, wherein the diameter of the plurality of wires is approximately 2 mm or less, wherein a pitch of the plurality of wires is less than 4.0 mm.

According to a second broad aspect, the present disclosure provides a wetted-wire liquid-gas contactor device comprising: a plurality of wires; a first support structure configured to retain the plurality of wires at one end in a fixed position; a second support structure configured to retain another end of the plurality of wires in a fixed position; and a liquid distribution system for receiving and distributing a liquid to the plurality of wires, wherein the diameter of the plurality of wires is approximately 2 mm or less, wherein a pitch of the plurality of wires is less than 4.0 mm.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 illustrates an exemplary prior art carbon capture system according to one embodiment of the present disclosure.

FIG. 2 illustrates a timeline for the development of wetted-wire literature according to one embodiment of the present disclosure.

FIG. 3 illustrates an exemplary disclosed carbon capture system according to one embodiment of the present disclosure.

FIG. 4 illustrates exemplary loose packings according to one embodiment of the present disclosure.

FIG. 5 illustrates exemplary structured packings according to one embodiment of the present disclosure.

FIG. 6 illustrates exemplary grids or lattices according to one embodiment of the present disclosure.

FIG. 7 illustrates the specific area of a column for different liquid vapor ratios in a column according to one embodiment of the present disclosure.

FIG. 8 illustrates the estimated specific area of a column compared to the estimated packing factor according to one embodiment of the present disclosure.

FIG. 9 illustrates evaporation rate versus gas stream pressure drop per unit length according to one embodiment of the present disclosure.

FIG. 10 illustrates a generalization of column effectiveness versus pressure drop per meter according to one embodiment of the present disclosure.

FIG. 11 illustrates wetted-wire heat exchanger configurations for capturing species from an exhaust stream according to one embodiment of the present disclosure.

FIG. 12 illustrates exemplary wetted-wire defining dimensions according to one embodiment of the present disclosure.

FIG. 13 illustrates a flow regime map according to one embodiment of the present disclosure.

FIG. 14 illustrates a wetted-wire heat exchanger configuration including turbulators according to one embodiment of the present disclosure.

FIG. 15 illustrates a vertical wire gas-liquid contactor design according to one embodiment of the present disclosure.

FIG. 16 illustrates exemplary fluid flowing on wetted-wires according to one embodiment of the present disclosure.

FIG. 17 illustrates exemplary sets of wetted-wire designs according to one embodiment of the present disclosure.

FIG. 18 illustrates liquid flow down exemplary parallel or nearly parallel wires according to one embodiment of the present disclosure.

FIG. 19 graphically illustrates the minimum allowable pitch distance for a variety of wire diameters according to one embodiment of the present disclosure.

FIG. 20 illustrates the pitch (center-to-center distance) in multiple arrangements according to one embodiment of the present disclosure.

FIG. 21 illustrates varies alternate wetted-wire heat exchanger configurations according to embodiments of the present disclosure.

FIG. 22 illustrates a conical nozzle design according to one embodiment of the present disclosure.

FIG. 23 illustrates a cylindrical nozzle design according to one embodiment of the present disclosure.

FIG. 24 illustrates an exemplary nozzle configuration according to one embodiment of the present disclosure.

FIG. 25 illustrates an exemplary deicing and/or defouling configuration for a wetted-wire heat exchanger configuration according to one embodiment of the present disclosure.

FIG. 26 illustrates another exemplary deicing and/or defouling configuration for a wetted-wire heat exchanger configuration according to one embodiment of the present disclosure.

FIG. 27 illustrates a vortex structure inside a bead and graphically illustrates improved mixing due to recirculating flow in the bead according to one embodiment of the present disclosure.

FIG. 28 graphically illustrates increased surface area density according to one embodiment of the present disclosure.

FIG. 29 illustrates various applied scenarios for a liquid distribution system according to one embodiment of the present disclosure.

FIG. 30 illustrates an embodiment of a wetted-wire heat exchanger design according to one embodiment of the present disclosure.

FIG. 31 illustrates a liquid distribution plate configuration according to one embodiment of the present disclosure.

FIG. 32 illustrates a nozzle assembly according to one embodiment of the present disclosure.

FIG. 33 illustrates a variety of liquid distribution systems according to one embodiment of the present disclosure.

### DETAILED DESCRIPTION OF THE INVENTION

### Definitions

Where the definition of terms departs from the commonly used meaning of the term, applicant intends to utilize the definitions provided below, unless specifically indicated.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,” is not limiting.

For purposes of the present disclosure, the term “comprising”, the term “having”, the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90° in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, it should be noted that to provide a more concise description, some of the quantitative expressions given herein are not qualified with the term “about.” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For purposes of the present disclosure, the term “bead” refers to the portion of flow on a wire which has two radii of curvature meaning it is ellipsoidal, spherical, or globular, rather than a cylindrical film which is often referred to as “annular”.

For purposes of the present disclosure, the term “chemical compound” refers to a chemical substance composed of many identical molecules (or molecular entities). Each molecule or molecular entity is composed of one or more atoms from one or more more elements held together by chemical bonds.

For purposes of the present disclosure, the term “chemical species” or “species” refers to a chemical substance or ensemble composed of chemically identical molecular entities that can explore the same set of molecular energy levels on a characteristic or delineated time scale. These energy levels may determine the way the chemical species will interact with others (engaging in chemical bonds, etc.). The disclosed species can be atom, molecule, ion, radical, and have a chemical name and chemical formula. The term may also be applied to a set of chemically identical atomic or molecular structural units in a solid array. In some embodiments species may refer to a chemical substance, an ensemble of chemicals, or a chemical compound.

For purposes of the present disclosure, the term “concentric objects” refers to two or more objects that share the same center or axis. In geometry, two or more objects arranged in this orientation may also be referred to as concentric, coaxal, or coaxial. Circles, regular polygons and regular polyhedra, and spheres may be concentric to one another, as may cylinders.

For purposes of the present disclosure, the term “condensation” refers to the change of the state of matter from the gas phase into the liquid phase, and is the reverse of vaporization. It can also be defined as the change in the state of water vapor to liquid water when in contact with a liquid or solid surface. Sometimes condensation to refers to both its strict definition (vapor to liquid transition) and to include desublimation (vapor to solid).

For purposes of the present disclosure, the term “desiccant” refers to a hygroscopic substance that is used to induce or sustain a state of dryness (desiccation) in its vicinity; it is the opposite of a humectant. Desiccants for specialized purposes may be in forms other than solid, and may work through other principles, such as chemical bonding of water molecules.

For purposes of the present disclosure, the term “desublimation” refers to the phase transition in which gas transforms into solid without passing through the liquid phase.

For purposes of the present disclosure, the term “desublimator” refers to a heat exchanger that causes a species to desublimate such as CO₂ at low temperatures.

For purposes of the present disclosure, the term “flue gas” refers to the emitted material produced when fossil fuels such as coal, oil, natural gas, or wood are burned for heat or power. Flue gas may contain pollutants such as particulates, sulfur dioxide, mercury, and carbon dioxide. Most flue gas, however, consists of nitrogen oxides.

For purposes of the present disclosure, the term “fluid” refers to a liquid, gas, or other material that continuously deforms (flows) under an applied shear stress, or external force. They have zero shear modulus, or, in simpler terms, are substances which cannot resist any shear force applied to them. Fluid properties include lack of resistance to permanent deformation, resisting only relative rates of deformation in a dissipative, frictional manner, and the ability to flow (also described as the ability to take on the shape of the container).

For purposes of the present disclosure, the term “fluid flow” refers to generally the motion of a fluid that is subjected to different unbalanced forces. It is mainly a part of fluid mechanics and fluid flow generally deals with the dynamics of the fluid. The motion of the fluid continues until different unbalanced forces are applied to the fluid.

For purposes of the present disclosure, the term “liquid” refers to a nearly incompressible fluid that conforms to the shape of its container but retains a (nearly) constant volume independent of pressure. As such, it is one of the four fundamental states of matter (the others being solid, gas, and plasma), and is the only state with a definite volume but no fixed shape. A liquid is made up of tiny vibrating particles of matter, such as atoms, held together by intermolecular bonds. Like a gas, a liquid is able to flow and take the shape of a container.

For purposes of the present disclosure, the term “nozzle” refers a device designed to control the direction or characteristics of a fluid flow (especially to increase velocity) as it exits (or enters) an enclosed chamber or pipe. A nozzle may include a pipe or tube of varying cross sectional area, and it can be used to direct or modify the flow of a fluid (liquid or gas). Nozzles may be used to control the rate of flow, speed, direction, mass, shape, and/or the pressure of the stream that emerges from them. In some embodiments, in a nozzle, the velocity of fluid may increase at the expense of its pressure energy.

For purposes of the present disclosure, the term “room temperature” refers to a temperature of from about 20° C. to about 25° C.

For purposes of the present disclosure, the term “tower” refers to an enclosed gas-liquid contactor. The disclosed tower may include an absorber, a heat exchanger, or mass exchanger.

For purposes of the present disclosure, the term “trickle bed reactors” refers to a chemical reactor that uses the downward movement of a liquid and the downward (co-current) or upward (counter-current) movement of gas over a packed bed of (catalyst) particles. It may be considered to be the simplest reactor type for performing catalytic reactions where a gas and liquid (normally both reagents) are present in the reactor and accordingly it is extensively used in processing plants. Typical examples may include liquid-phase hydrogenation, hydrodesulfurization, and hydrodenitrogenation in refineries (three phase hydrotreater) and oxidation of harmful chemical compounds in wastewater streams or of cumene in the cumene process. Also in the treatment of waste water, trickle bed reactors may be used where the required biomass resides on the packed bed surface.

For purposes of the present disclosure, the term “vessel” refers to a containment system that ensures that a specific type of gas comes into contact with a specific liquid. It is noted that not all applications of a wetted-wire system have a vessel—for example, a decorative lamp, or a swamp cooler.

For purposes of the present disclosure, the term “viscosity” refers to the quantification of the internal frictional force between adjacent layers of fluid that are in relative motion.

For purposes of the present disclosure, the term “viscosity of a fluid” refers to a measure of a fluid's resistance to deformation at a given rate. For liquids, it corresponds to the informal concept of “thickness.”

### Description

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

Under many national-level clean-air regulations, power plants and other industrial facilities are required to use flue gas treatments to reduce the amount of emitted pollutants. Such approaches, which use devices such as electrostatic precipitators and scrubbers, can successfully remove ninety percent or more of certain pollutants. However, they can be very costly to install and operate, and requirements for exhaust gas treatment frequently provoke complex legal battles. Treatments vary widely from one plant to another, and some countries have far-stricter requirements than others. Emissions from utilities and industries in countries with less-stringent pollution laws are a concern for environmentalists.

In some cases, it is desirable to capture a species from the exhaust gas, for example, generated from power plants and other industrial facilities. Spray towers, packed columns, tray towers, and bubblers are all used industrially for a variety of applications for liquid/vapor heat and/or mass exchanger which may be employed in the treatment of some exhaust gas treatment systems. These applications may include direct contact heat exchange, distillation, scrubbing, stripping, absorbing, and removing particles. Among these columns, there is a general tradeoff between performance and pressure drop across the column.

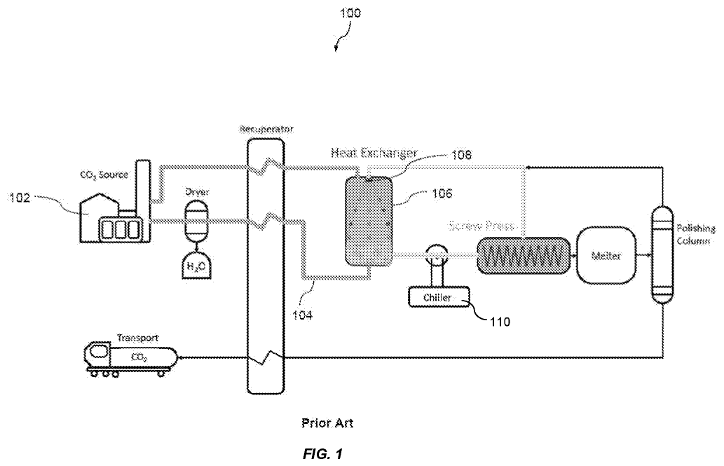

In one prior art arrangement, FIG. 1 illustrates an exemplary configuration wherein exhaust gas is expelled from a carbon rich source (e.g., power plant) and is further captured and processed in subsequent operations. For example, a cryogenic carbon capture system (CCC) 100 may include a power source 102 such as an industrial facility, a power plant, etc., that expels exhaust gas such as within an exhaust gas stream. In some embodiments, the exhaust gas may be regarded as a CO₂ source. Exhaust gas, for example, in the form of flue gas may be supplied via conduit 104 to heat exchanger 106. In one embodiment, heat exchanger 106 may be provided as a desublimating heat exchanger. During processing, a chiller 110 may be employed to cool the flue gas such that CO₂ within the flue gas turns to solid. In this design, a spray tower 108 may be implemented within heat exchanger 106 and employed to spray droplets to facilitate a heat exchange process wherein the chilled CO₂ turns to solid on the droplets. However, one drawback of spray tower 108 is that the droplets produced may not provide sufficient surface area to efficiently capture all of the available solidified CO₂.

It is readily appreciated that an objective of the spray tower 108 is to produce small droplets that are very uniform spatially so that very uniform temperatures are achieved, since the temperature may dictate completely how much CO₂ is removed. Thus, if non-uniformities in temperature occur, there may remain higher amounts of CO₂ than desired, or some regions may be cooled colder than desired. Accordingly, it is preferable to obtain very uniform temperatures and very uniform droplets to produce a desirable surface to volume ratio. If the droplets are too big, then surface area may be lost. If the droplets are too small, the flue gas, for example, moving upwardly in a convective stream may simply carry the droplets away. Thus, disclosed embodiments contemplate providing improved techniques and designs for providing an optimal droplet size and an optimal droplet trajectory.

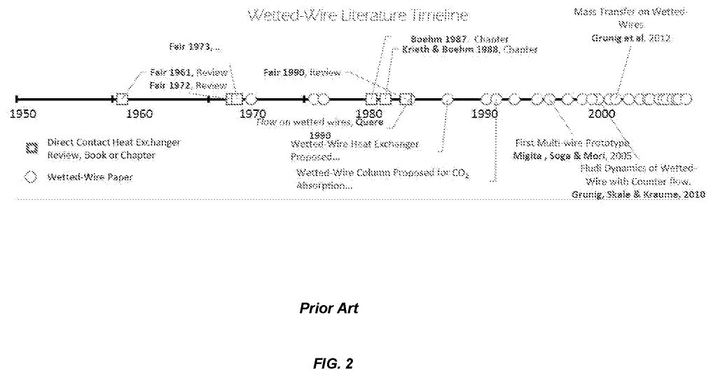

Direct-contact heat exchangers have been developed that involve energy exchange between gas and liquid streams have a variety of applications, including waste heat recovery, thermoelectric power plant cooling, and thermal desalination. Additionally, direct-contact heat exchangers are appealing as they may help mitigate potential corrosion, fouling, and scaling of solid surfaces and enhance heat transfer effectiveness. FIG. 2 illustrates a timeline for the development of wetted-wire literature.¹⁻³² While some wetted-wire heat exchangers have been developed, they do not provide for combined environments including, for example, species capture (e.g., CO₂) in desublimation (such as cryogenic capture) applications.

Other traditional alternatives may be utilized such as configurations incorporating packed column(s) (e.g., corrugated metal). However, packed column(s) have a history for poor solids handling. Such designs can produce “dead zones,” “dead areas,” or film areas with less circulation than others thereby being prone to solids accumulation as further explained below. Thus, there is a need to provide improved control of the droplet size, the trajectory of the droplet and, hence, fluid flow to enhance the disclosed heat exchange process, make the heat transfer process more efficient, and increase the species (e.g., CO₂) capture rate from an exhaust stream.

Disclosed embodiments provide direct contact heat exchangers based on wetted string columns that offer an intriguing alternative to other conventional designs such as packed beds and spray columns. In one disclosed embodiment, the invention is directed to an exhaust gas capture system, which may capture chemical species in the exhaust gas at low temperature (e.g., desublimation) utilizing a wetted-wire heat exchanger. In some disclosed embodiments, the exhaust has may include a flue gas. The main prototype may include a CO₂ capture system and/or a water removal system, which may be modified to capture other species in flue gas such as SOₓ, NO₂, NO₃, CO, and NO.

Arrays of wetted-wires (wetted-wire columns) have been used as decoration, and have been proposed and prototyped for industrial purposes. However, a key dimensions of conventional wetted-wired designs have not been optimized for industrial applications. The disclosed device is related to improving conventional systems including providing an optimized center-to-center distance between the wires—the pitch.

According to disclosed embodiments, wetted-wire columns (even non-optimized ones) have several particular advantages that make them well suited for applications not yet proposed. The present disclosure provides parameters of key importance include low-temperature pollutant removal by method of condensation or desublimation.

In some embodiments, wetted-wires systems may be extended to be used for more viscous liquids such as heavier amines for CO₂ scrubbing, or potentially handling solids (e.g., better than other conventional processes). Other applicable processes include those that are very sensitive to pressure drops and those requiring a very low pressure drop, such as in vacuum distillation.

The disclosed design provides a means of controlling both droplet size and droplet trajectory. In short, due to the disclosed wetted-wire design, the trajectory of the droplet(s) has to follow the wire configuration. The wires may be disposed at optimal locations for generating the required uniform temperature; and by changing the ratio of the device (such as a nozzle) that generates the droplet(s) that falls on the implemented wetted-wire design, the droplet size may be controlled.

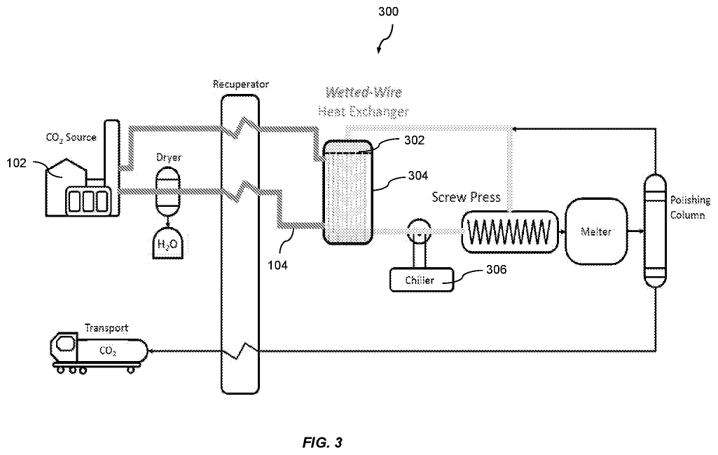

FIG. 3 illustrates another exemplary configuration wherein exhaust gas is expelled from a carbon rich source (e.g., power plant) and is further captured and processed in subsequent operations. For example, a cryogenic carbon capture system (CCC) 300 may include a power source 102 such as an industrial facility, a power plant, etc., that expels an exhaust gas such as within an exhaust gas stream. In some embodiments, the exhaust gas may be regarded as a CO₂ source. Exhaust gas, for example, in the form of flue gas may be supplied via conduit 104 to heat exchanger 304. In this embodiment, heat exchanger 304 may be provided as a desublimating heat exchanger. During processing, chiller 306 may be employed to cool (such at cryogenic temperatures) the flue gas such that CO₂ in the flue gas turns to solid. However, the disclosed design provides a wetted-wire configuration 302 disposed and implemented as a heat exchanger 304 in efforts to recover CO₂ by capturing the chilled CO₂ along liquid coolant droplets produced by the disclosed embodiment and running along the wires of the wetted-wire configuration.

In accordance with disclosed embodiments, a minimum viable unit is roughly defined by two dimensions, much in the way that previous “packings” have been defined by several key dimensions. Historically, there have been several “packings” or internal structures used within columns for many applications. These columns can be categorized as (1) Loose “Random” Packing (2) Structured Packing (3) Trays (4) Grid “Packing.”

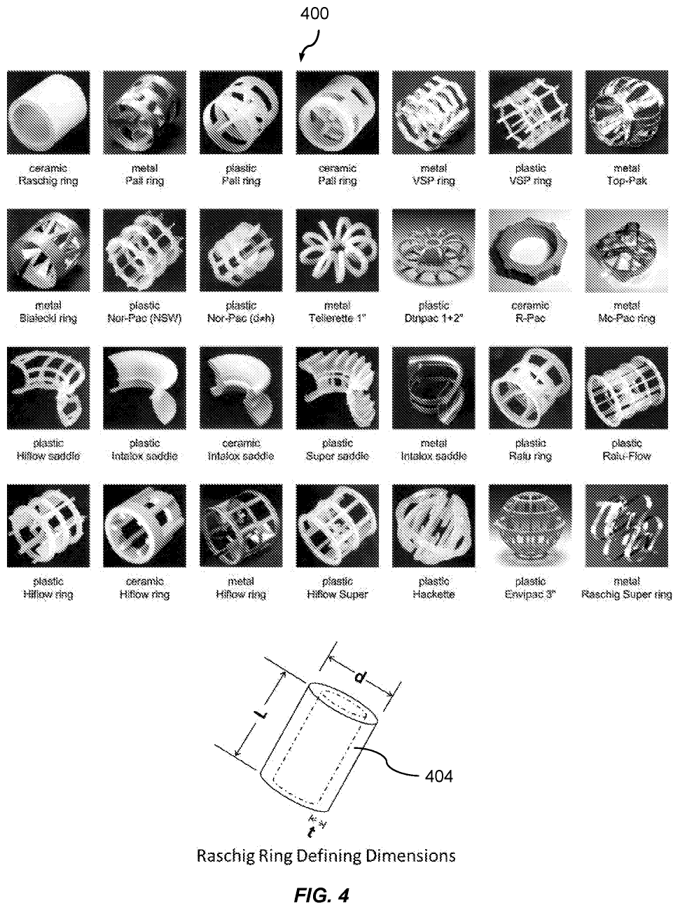

As illustrated in FIG. 4, loose packings 400 are loose metal, plastic, or ceramic units which enhance mixing of liquid and gas within a column. The simplest of these, the Raschig ring 404, is defined by a thickness, diameter and length.

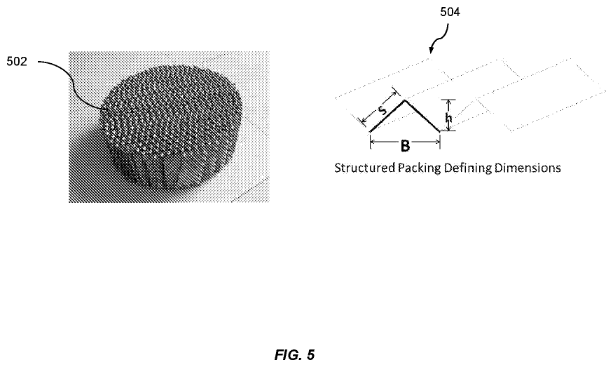

As illustrated in FIG. 5, structured packings 502 are made from corrugated metal or plastic. They may also be defined by three critical dimensions 504, and also an orientation angle (almost exclusively 45 degrees or 60 degrees.)

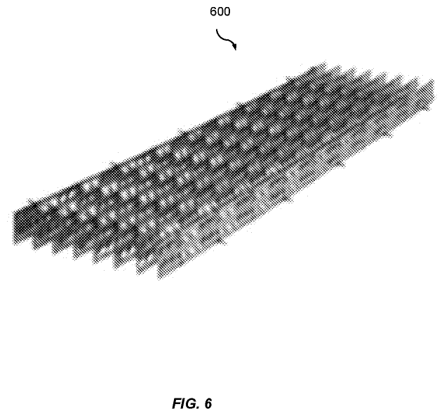

As illustrated in FIG. 6, grids or lattices 600 are several loose grids which catch falling droplets, and then reform as new droplets. Grids are comparatively new, and used for applications where the pressure drop is desired to be low. Grid drawbacks include issues with having a low interfacial surface area and a low residence time for the liquid (i.e., the droplets tend to fall quickly).

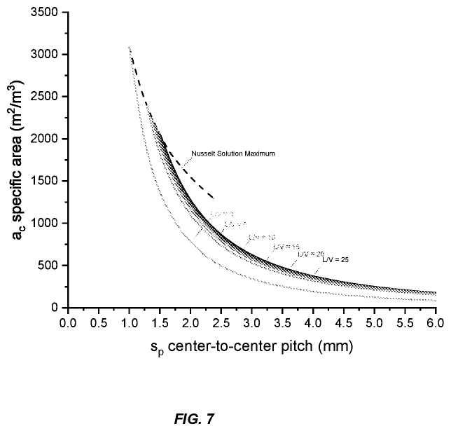

In evaluating key advantages of a small pitch, FIG. 7 is referenced. The specific area of the column for different liquid vapor ratios in a column is shown. This is for a 1 mm wire, infinite diameter, triangular packed column and a working fluid of water. In accordance with disclosed embodiments, as the pitch is reduced, the interfacial area greatly increases.

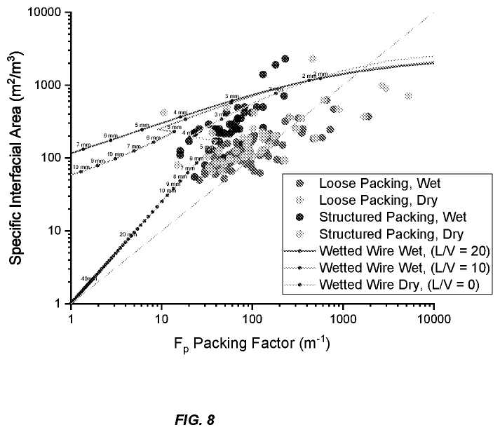

Referencing FIG. 8, the specific area of the column is very high especially compared to the estimated packing factor. The packing factor is estimated for a 1 mm wire, infinite triangular packed column and a working fluid of water. The packing factor may be regarded as a single number which gives an indication of the gas-side pressure drop and how hard it is to push the gas counter-currently upward through the packing. A high packing factor indicates a high pressure drop. Low packing factor indicates a low pressure drop low. The specific interfacial area and the packing factors are shown for a variety of packings listed in the 9th edition of Perry's Chemical Engineers' Handbook. Note that the points above the red line in of FIG. 8 are for Mellopac and are likely a representation of their mesh material area and not the actual interfacial area.

According to disclosed embodiments, as the pitch is reduced, the downward average velocity of the fluid will be reduced. This will further increase the residence time of the liquid.

Packed columns have been utilized for a variety of liquid-gas systems industrially. This includes many of applications that may be typically described as distillation, gas absorption, phase dispersion, and/or phase separation. For a specific application, a traditional choice has often been between a spray tower, bubble column, trayed column or packed column. The choice between these has been complicated and very application dependent. It is therefore purported by disclosed embodiments to select a wetted-wire column for a specific application because of its unique advantages as discussed herein

One parameter that is oftentimes a concern is the pressure drop per height of a tower. There is a trade-off that generally exists for the choice of tower. Packed towers have excellent performance but a high pressure drop, while spray towers have low pressure drop and low performance. The pressure drop changes depending on how fast the liquids and gases are flowing which may be described by the packing factor. The pressure drop increases if more air is blown through the column. The packing factor may describe overall pressure drop.

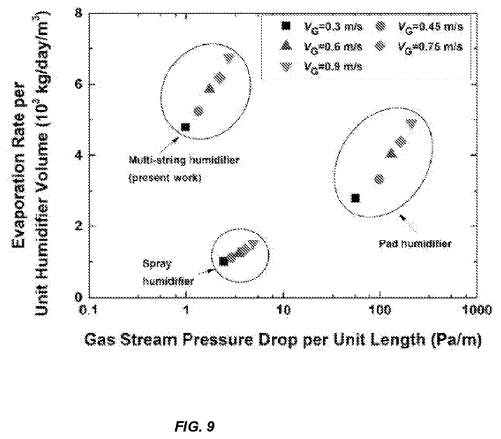

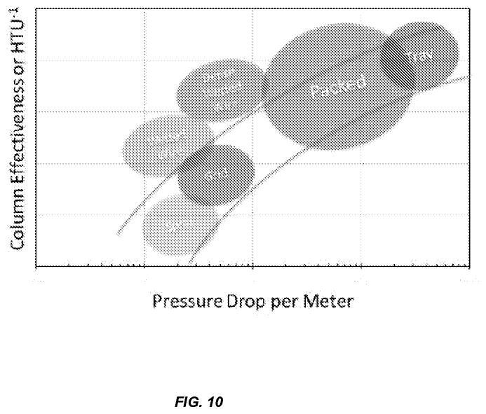

Some effort has contemplated wetted-wire columns. For example, some prior art embodiments (e.g., utilizing a 5 mm+ pitch) proposes wetted-wire columns called a “multi-string humidifier.” FIG. 9 graphically illustrates evaporation rate versus gas stream pressure drop per unit length. FIG. 10 is an image adapted from FIG. 9 and from Perry's Chemical Engineers' Handbook. FIG. 10 graphically illustrates a generalization of column effectiveness versus pressure drop per meter. It is, therefore, noted that a similar pressure drop is observed as compared to a spray tower, however, the performance is better. In the case of a densely arranged wetted-wire column the performance would be even better, but with an increase in pressure drop. Thus, disclosed embodiments have determined that a dense wetted-wire heat exchanger may serve as an improved substitute over spray tower, grid and packed column design applications.

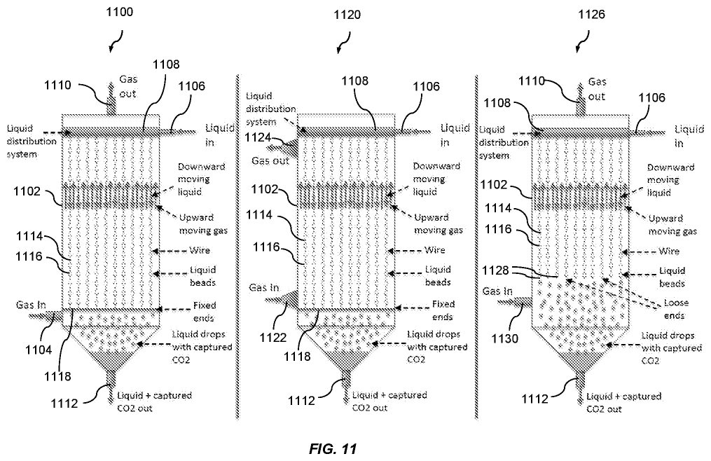

Accordingly, some disclosed embodiments provide a system that uses a direct contact heat and mass transfer technique to separate CO₂ from a stream of flue/exhaust gases. This disclosure contemplates the application of a wetted-wire heat exchanger for the desublimation of carbon dioxide at low tempuratures (used as a carbon capture technique). A schematic of one embodiment of a wetted-wire heat exchanger configuration 1100 for CO₂ capture from flue gases is illustrated in FIG. 11 according to one embodiment of the present disclosure. Flue gas enters the bottom of the heat exchanger vessel 1102 through a gas inlet 1104 which may be configured as a single gas nozzle or a gas distributor/sprayer. The flue gas can have a CO₂ volumetric concentration anywhere from 1-25% depending on the process from which the gas has formed. The gas enters the heat exchanger just above the atmospheric pressure and at approximately −100° C. temperature. Liquid enters at the top of the vessel at coolant inlet 1106. In some embodiments, the liquid may be a coolant. The liquid may enter the top of the vessel, for example, at temperatures ranging from approximately −110° C. to −135° C., into a liquid distribution system 1108. In one embodiment, the liquid may be collected in a pool whereupon the liquid may then drip (flows downwardly) along multiple thin wires 1114 positioned vertically or inclined at a slight angle with respect to the axis of the vessel. In another embodiment, nozzles may be provided in liquid distribution system 1108 for providing a liquid flow along multiple thin wires 1114 as explained below. As the contact liquid flows down, it forms a series of equi-spaced beads 1116 that enhance the heat and mass transfer between the gas and the liquid. A configuration of wetted-wire heat exchanger configuration 1100 may provide a support structure 1118 for fixedly attaching ends of wires 1114. As shown, support structure 1118 is configured above gas inlet 1104. As the gas flows upwards, it cools further below the desublimation temperature of CO₂ and results in freezing it on the surface of the downward flowing liquid. A gas outlet 1110 may be configured to release gas, for example, at a top of the vessel 1102 and above liquid distribution system 1108. The liquid and the captured CO₂ are collected at the bottom of the vessel. The liquid and the captured CO₂ may be released at outlet 1112 and directed towards a separation process to regain the fresh liquid.

Alternate embodiments of the disclosed wetted-wire heat exchanger configuration may be provided in order to influence properties and characteristics of fluid flow and desublimation phenonmenon. Accordingly, alternate configurations are provided by the disclosed invention. For example, in the configuration of the wetted-wire heat exchanger configuration 1120, an alternate gas inlet 1122 position is provided. Gas inlet 1122 is disposed above the support structure 1118 for fixedly attaching ends of wires 1114. Gas outlet 1124 is configured below liquid distribution system 1108.

In the configuration of the wetted-wire heat exchanger configuration 1126, wires 1114 may be provided as truncated wires. In this configuration, wires 1114 may supported by support structure from above, for example, at liquid distribution system 1108. The ends of wires 1114 may hang as loose ends 1128 and, in some embodiments, above a location of gas inlet 1130. Wetted-wire heat exchanger configuration 1126 may provide gas outlet 1110 at a top of the vessel 1102 and above liquid distribution system 1108.

### Wetted Wire

Accordingly, embodiments of the disclosed wire in this context may be defined as a roughly cylindrical structure, with a significantly high aspect ratio (>4), and with a diameter small enough to cause instabilities (also known as beads, drops, or droplets) when a liquid flows down the wire. The diameter of the disclosed wire is preferably relatively small so that instabilities (droplets/beads) form on them. In some embodiments, the wire diameter ranges from 0.2 mm to 3.0 mm in diameter. Some preferred embodiments utilize wire diameters that are 2.0 mm or less. In accordance with disclosed embodiments, an optimum diameter is approximately 0.8 mm for non-polar liquids and 1.0 mm for water. Wires that are very thin yield droplets that fall relatively quickly, which is undesirable. Some embodiments may provide for wires that are hollow (e.g., for receiving refrigerant) or filled.

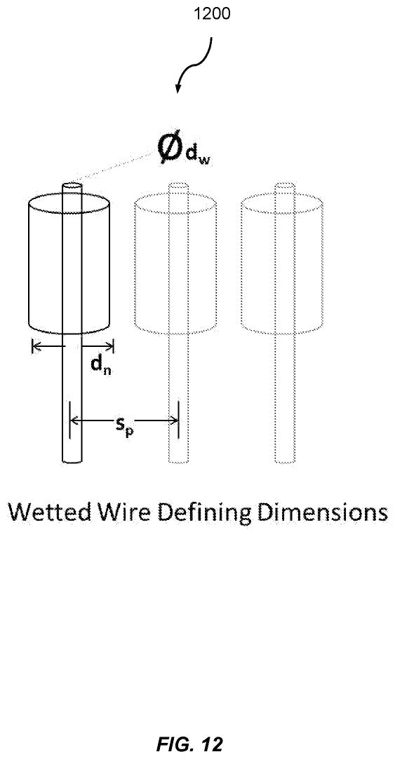

As illustrated in FIG. 12, exemplary wetted-wire configuration 1200 is illustrated having defining dimensions disclosed as: (a) wetted-wires, d_{w} wire diameter (b) wire density, Sₚ wire pitch (center to center distance between wires) (c) liquid distribution, dₙ nozzle diameter.

Disclosed embodiments provide wires that produce absolute instabilities (Raleigh Plateau Regime) in a liquid flowing down it. Therefore, wire diameter is approximately 0.8 mm for organic liquids or 1.0 mm for water. Too large of wires would produce convective (Kapitza) instabilities, and even larger ones would produce no instabilities at all.

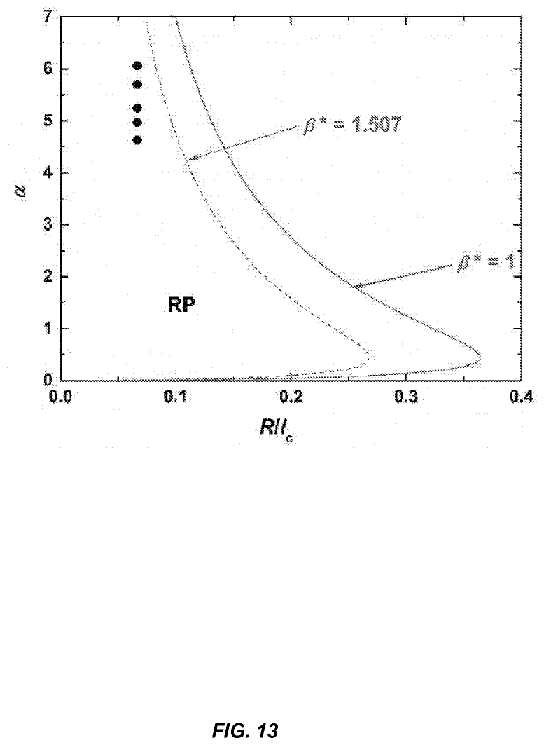

In one study of a flow regime map, reference is made to FIG. 13 which provides an exemplary graphical illustration of liquid flow rates. The Raleigh Plateau Regime (absolute Instabilities) occur when the saturation number, β*, is greater than 1.507

$${β}^{*} = {( \frac{\tilde{α}}{{Go}^{2} {c}_{k} {\tilde{α} ( 1 + \tilde{α} )}^{4}} )}^{2 / 3} = f ( Go , \tilde{α} ) \\ Go = \sqrt{\frac{Bo}{2}} = \frac{{d}_{wire} / 2}{{l}_{c}} \\ {l}_{c} = \sqrt{\frac{γ}{ρ g}} \\ \tilde{α} = \frac{{h}_{Nu}}{{l}_{c}}$$

In accordance with disclosed embodiment, it is desirable to stay within the Raleigh Plateau Regime, i.e., to be on the left side of the graph in FIG. 13, which is roughly left of a Goucher number of 0.2. Thus,

2Go*l_c=2(0.2)(2.0 mm OR 2.7 mm)=d_wire=0.8 mm or 1.00 mm

Accordingly, disclosed embodiments conclude preferable wire diameter effectively to be 0.8 mm diameter wires for organic liquids and 1.0 mm wires for water.

WIRE MATERIALS: Preferred material of the wire may include nylon, Teflon, metals, any fibrous material, polyethylene, cotton, cellulosic, and other synthetics. However, the tension to straighten the wire should be relatively low; so other materials such as rubbers and elastic may be included as well. Accordingly to disclosed embodiments, metal wires will not significantly increase the efficiency of heat transfer, because the droplets travel down the wires much faster than the speed of heat conduction. The wire material should be not too brittle for the application such as low temperatures; the wire material should not degrade, plasticize nor expand in the presence of a solvent or CO₂.

ANGLE OF THE WIRES: According to disclosed embodiments, the disclosed wires may be arranged vertically or incline at a particular angle from the vertical direction. If the incline of the wires is too great, then the droplets may fall off of the wire. The maximum allowable wire incline is dependent upon several factors. In general the thicker the wire, the more the tower can be inclined. The maximum preferred incline is likely to be around 45 degrees, which is similar to the incline of corrugated packing. The incline may also likely effect the minimum allowable pitch as discussed herein. In one exemplary embodiment, a maximum allowable incline for water and organic solvents is around 15-20 degrees for “fishing line” wire diameters around 0.5 mm.

In a preferred embodiment, the disclosed wires may be tensioned by securing the wires at the top and bottom of the tower.

In one disclosed embodiment, the wires may be generally smooth without any obstructions such as bulbs curves or dents if used within a densely packed column. Although counterintuitive, this is because large bulbs, dents or notches may be likely to stabilize the instabilities (drops), and/or cause bridges to occur between wires.

LENGTH OF THE WIRES: In some disclosed embodiments, the length of the wetted-wires is adjusted so that a lower end of the wetted-wires is not in contact with the liquid with captured gas species at the bottom of the vessel in order to prevent heat transmission along the wire.

ROUGHNESS: If the wires are too rough, theoretically the instabilities may be stabilized. Accordingly to some disclosed embodiments, this effect would be a function of the roughness relative to the thickness of the film. Because the film thickness varies, the Nusselt thickness h_{Nu} may be utilized. The maximum allowable roughness is some fraction of the the nusselt thickness: Max=Ra/h_{Nu}. The Nusselt thickness is the (mathematically calculated) thickness of a cylindrical film if surface tension forces are ignored. This thickness corresponds to a Nusselt Diameter which is the solution to the following equation.

$$128 ( \frac{μ Q}{πρ {gD}_{wire}^{4}} ) = [ - 3 {( \frac{{D}_{Nu}}{{D}_{wire}} )}^{4} + 4 {( \frac{{D}_{Nu}}{{D}_{wire}} )}^{2} + 4 {( \frac{{D}_{Nu}}{{D}_{wire}} )}^{4} ln ( \frac{{D}_{Nu}}{{D}_{wire}} ) - 1 ]$$

Where Q is the volumetric flow of liquid down the wire, m is the viscosity, rho is the density, g is gravitational acceleration, and D.wire is the diameter of the wire. Accordingly, a braided wire is likely not desired due to its “roughness.”

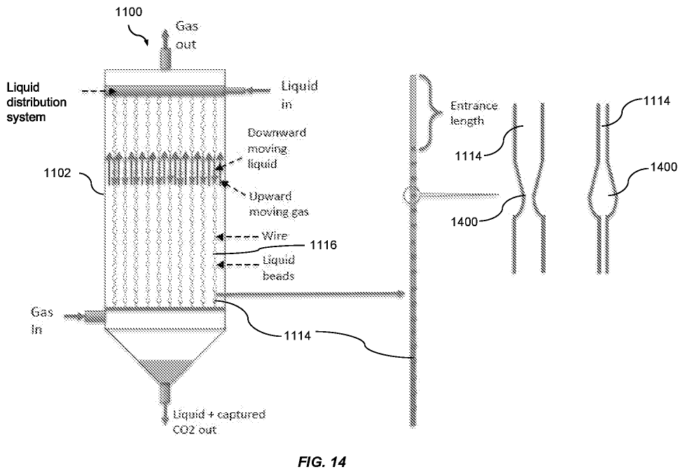

If operating at a lower wire density (or after experimentation), the disclosed wetted-wire heat exchanger wires may be fashioned as turbulators. FIG. 14 illustrates a wetted-wire heat exchanger configuration 1100 wherein the one or more of the multiple thin wires 1114 includes turbulators 1400 according to one embodiment of the present disclosure. The turbulators 1400 may obtain multiple configurations including, for example, large bulbs, curves, or dents and/or be fashioned as projections on the wires 1114. Turbulators 1400 enhance the liquid circulation in the beads and may improve the interfacial heat and mass transfer. Turbulators 1400 may also assist in breaking any ice shells, for example, developed as a result of employing coolants and lower temperature ranges. The disclosed turbulators 1400 may induce more mixing, especially circulating flows around the wire 1114.

TWIST OF THE WIRES: The twists may serve a similar purpose(s) as the turbulators above.

PITCH: Accordingly, to one disclosed embodiment, the pitch is the minimum center-to-center distance between wires within an arrangement shown as sₚ, at any point within the column. It is noted that two wires that are next to each other in an “other” arrangement may in fact be further apart than the minimum distance commonly found between two neighboring wires. This distance (m) is not the pitch, because sₚ is smaller. It is also noted that using a rectangular pitch would not sidestep this definition, because sₚₓ would be a minimum compared to s_{py}. Furthermore, it is noted that if a wire arrangement is strung between two plates and one of the plates is rotated compared to the other, a hyperbolic shape may be created of roughly parallel wires. The minimum pitch would be found at the center, not at either plate.

Some authors propose literature on the phenomenon of droplets on wires. Using wetted-wire systems for heat or mass transfer in a column is an idea that has not received much attention compared to other column internals such as trays and structured packing. Wetted-wire heat exchangers were originally proposed in the 1990's. Afterwards a subset of groups has conducted research on wetted-wire columns.

Within these groups only a small number of multi-wire prototypes have been constructed. All of these prototypes have a center-to-center wire pitch of 5 mm or greater. See Table 1 for a summary of all of the chosen pitches for all the literature.

TABLE 1

| AUTHOR | PITCH | | TYPE |
|---|---|---|---|
| Migita | 6 | mm | Physical Apparatus |
| Grunig | 4 | mm | Used in Calculations |
| Galledari | 5 | mm+ | Model |
| Padehri | 9 | mm | Physical Apparatus |
| Zeng | 7 mm, 10 mm | | Physical Apparatus |
| Sadeghpour | 5 | mm | Unreported Physical |

Apparatus (Dehumidifier)

The groups omitted from Table 1 do not discuss pitch. Some authors discuss the minimum theoretical pitch. For example Zeng discusses within his thesis, “[t]he smallest practical string pitch is estimated to be of the order of 5 mm, constrained in part by liquid flooding at the air inlet and in part by interference between liquid films flowing down adjacent strings” Sadeghpour says, “[t]he smallest pitch presented many practical challenges in manufacturing and assembly”. And Grunig et al. determine that a pitch of 4 mm “seems to be reasonable.”

Embodiments of the present disclosure, however, provide that any wetted-wire column that has a center-to-center pitch on the order of anything less than 4 mm is unique and not obvious. This observance is not obvious, because previous researchers assumed that it wasn't feasible to have a small (less than 4 mm pitch). Furthermore, disclosed embodiments provide that increasing the pitch greatly increases the effectiveness of the column, because of the increase in surface area and decrease of liquid flow per wire.

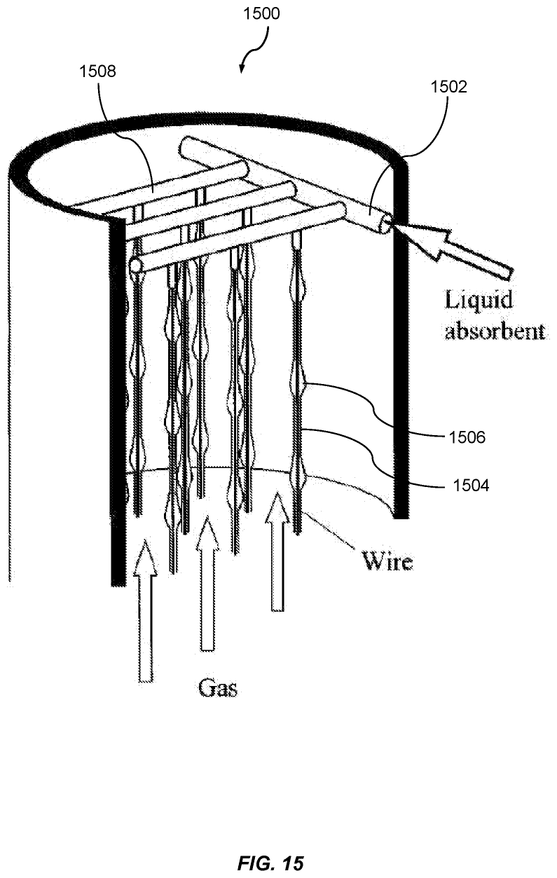

FIG. 15 illustrates the concept of a liquid-inlet portion 1502 in a vertical wire gas-liquid contactor 1500. The design may be equipped with multiple wires 1504 which may support the flow of a string beads 1506, for example, liquid absorbent, which may be formed thereon. As shown in FIG. 15, the image for a wetted-wire design shows a very large pitch size (Chinju, Uchiyama and Mori). This concept envisions a heat exchanger including, for example, a pipe liquid distributor 1508, which would require a relatively large pitch to accommodate the size of the pipes.

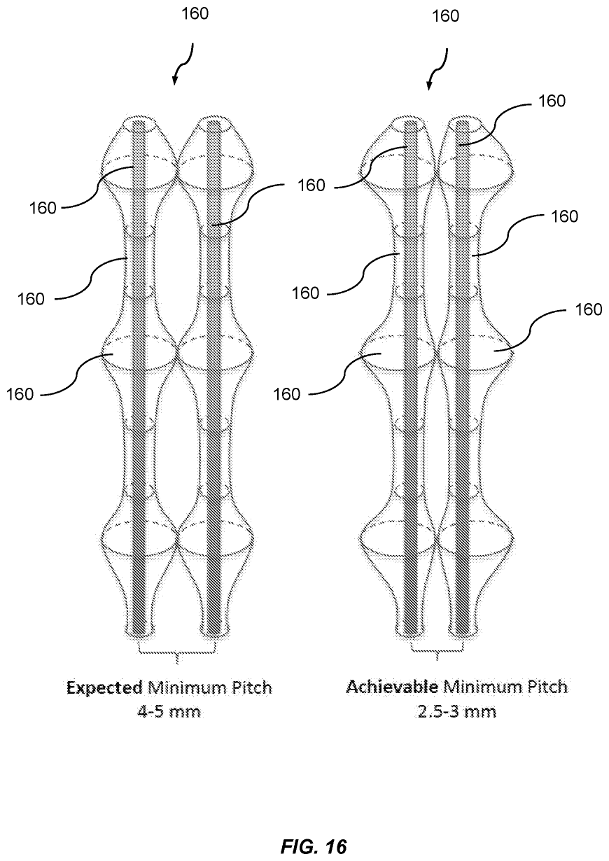

Referring to FIG. 16, a minimum pitch configuration 1600 and an achievable minimum pitch configuration 1602 is illustrated. Wetted wires 1604 support a fluid flow 1606 having beads 1606 flowing thereon. It has been generally thought that when two beads touch, that would result in a catastrophic failure (e.g., undesirable flow along the wetted wires). Merging of beads is undesirable, because it significantly reduces the interfacial surface area within the column. If merging occurs, a phenomenon may be created roughly wherein one column of liquid may form around two wires instead of two columns of liquid around two wires. (In other words, the merging of two or more wetted wires is undesirable wherein one film covers multiple wires.) Thus, the interfacial area is roughly reduced to half of the original surface area. Instead, according to disclosed embodiments, it is desirable that the beads 1608 avoid each other as they flow along wetted wires 1604. It is not until a bead 1608 touches an annular (non-bead film) portion of fluid that a catastrophic failure actually occurs. For this reason, disclosed embodiments have determined that the pitch can be very small. Accordingly, up until the present disclosure, it was not so obvious that approximately 4-5 mm pitch could be achieved as illustrated, for example, in the minimum pitch illustration 1600. In fact, disclosed embodiments provide an achievable minimum pitch configuration 1602 illustrating approximately a 2.5-3 mm pitch. This is achievable due to fluid dynamics phenomenon known as “bead passing” wherein the beads 1608 will push each other out of the way as they pass each other according to disclosed embodiments. Achieving and/or successfully utilizing the smaller pitch may be directly attributable to controlling the flow of liquid to a low flow level in accordance with some disclosed embodiments.

It is also noted that “messy” beads (e.g., non-uniform beads or globular non-elipsoidal beads),which occur under high counter-flows and thin wires, do not merge. They appear to avoid each other as well. Thus, disclosed embodiments illustrate that even in the worst or undesirable cases, the beads will expectantly avoid each other up to previously unconsidered points. Disclosed embodiments provide disposing wetted wires closer together than expected including, in some cases, smaller than a 4 mm pitch.

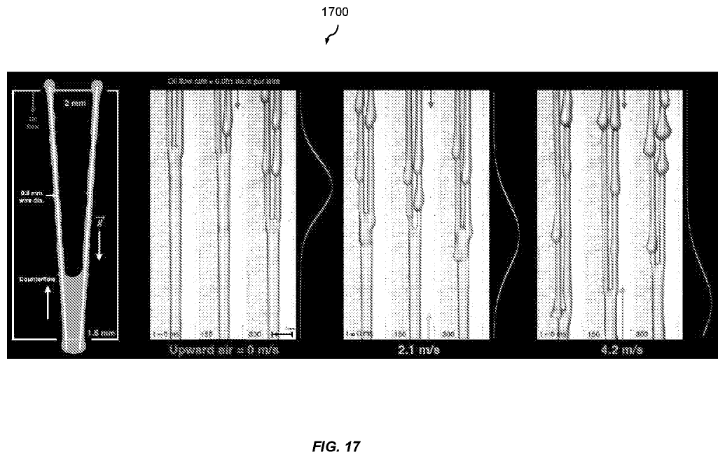

FIG. 17 illustrates a set of experiments used to try to determine the minimum feasable pitch for a wetted-wire heat exchanger. 1700. The experiments consisted of silicon oil droplets sliding down two slightly converging wires. Silicone coil droplets sliding down two slightly converging wires (clear) eventually coalesce when the distance between wires approaches the capillary length (1.97 mm). However, this distance required for merging decreases slightly if an upward gas flow is introduced. The location of the coalescence of the droplets is shown in three counter flows with identical silicone oil flow rates (0.05 mL/s per wire). Three photographs are shown for each flow rate to illustrate the spacings between droplets that can occur. The probability density functions (curves) of the coalescing location are also shown. The droplets tend to get larger as the flow increases making the oil layer on the wire smaller. This tends to decrease the wire distance required for coalescence. If the counter flow is too high (e.g, on the order of 4.5 m/s), then the droplets may break up and leave the wire as smaller droplets which is undesirable.

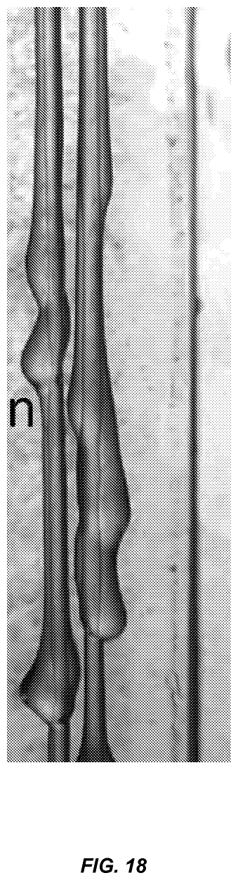

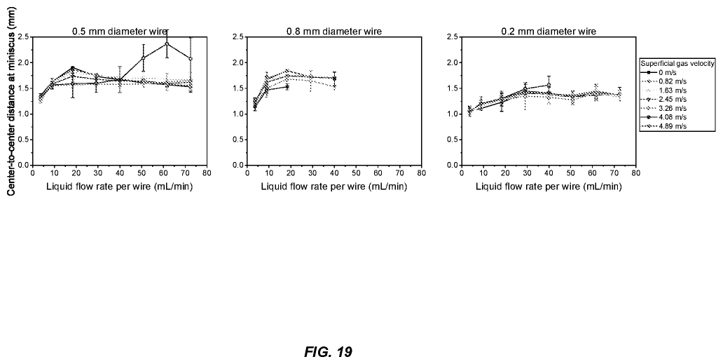

FIG. 18 illustrates a liquid flow down parallel or nearly parallel wires (not converging wires). These parallel or nearly parallel systems gave similar results in that the droplets actually avoid each other. Referencing FIG. 19 graphically illustrates the minimum allowable pitch distance for a variety of wire diameters according to the experiments described in FIG. 17. For 0.2 mm, 0.5 mm and 0.8 mm diameter wires the distance that causes merging (minimum allowable pitch) occurs at distances less than 2 mm for several combinations of liquid flow rates and gas flow rates. According to some disclosed embodiments, the gas upward velocity has very little effect on the allowable pitch size. Note that the minimum allowable pitch size is smaller than expected, because the droplets do not merge.

This effect of the beads passing by each other and not merging is most effective when the beads are falling at a fast enough rate. This means that the liquid on the wetted wire must not be too viscous. Low viscosity is typical of most industrial solvents including water.

This minimum theoretically desired pitch from FIG. 19 is so incredibly small, that manufacturers may be challenged against the limits of manufacturability (i.e., making small enough nozzles and/or holes for suitable wetted-wire configurations). Additional challenges exist in order to avoid merging at the initial liquid distribution onto the wires. Thus, in practical design, disclosed embodiments may employ a likely a pitch of 2.5 mm to 4.0 mm.

In accordance with embodiments, the disclosed wires may be placed at a small pitch size, therefore may be subjection certain accommodations. The first accommodation may include a carefully designed liquid distribution system as described below. A second accommodation may include a carefully designed gas inlet and outlet system. For example, if the gas stream is too fast at the inlet, it will encourage or blow the liquid stream(s) off the wire. (This may be prevented in a variety of ways as suggested in Perry's Chemical Engineering Handbook.)

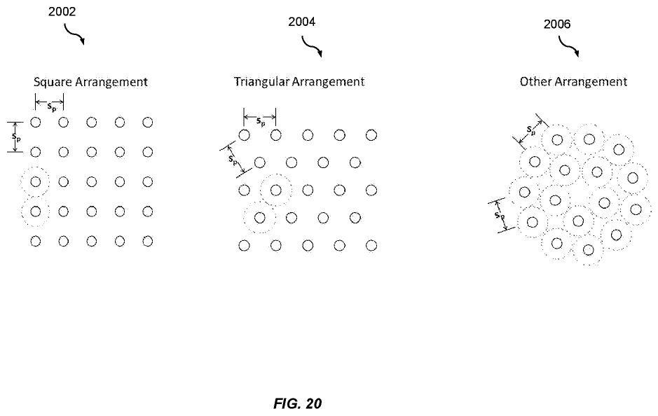

FIG. 20 illustrates the pitch (center-to-center distance) in three different arrangements according to one embodiment of the present disclosure. Accordingly to some disclosed embodiments, the pitch pattern could be arranged, for example, in a square pattern 2002 for small square channels, in triangular pattern 2004 for higher density, or even in a “sunflower” 2006 pattern for, at least, two possible applications: (1) cleaning of wires using a spray (2) initial liquid distribution using a spray (however, not likely). The sunflower pattern is typically the least efficient arrangement for larger columns where the ratio of the column diameter to the pitch are significantly large d.col/pitch>25. Other geometrical patterns may be utilized including, for example, a circular pattern.

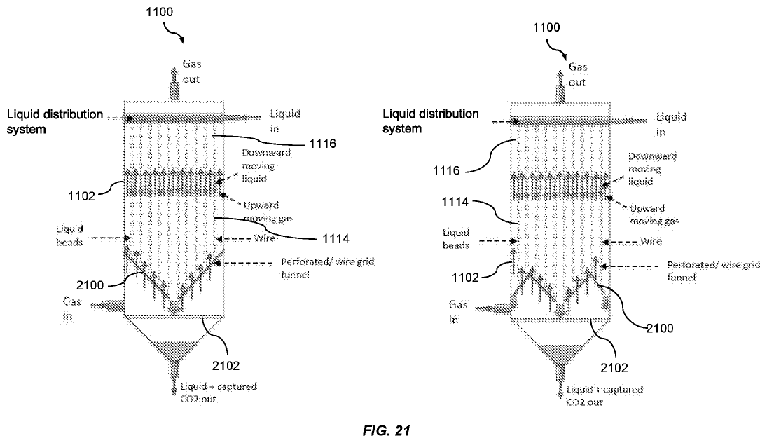

OPTIONAL WIRE GRID FUNNEL: Turning to the various disclosed wetted-wire heat exchanger configurations 1100 depicted in FIG. 21, embodiments illustrate that the lower end of the wires 1114 may be in touch with an inclined wire grid funnel 2100. Providing an included wire grid at the end may facilitate deflecting lighter liquid and assist in breaking away liquid beads from wires 1114. Beads 1116 on incline wire 1114 may be inclined to destabilize as other other beads merge from other merging wires 1114. The wire grid funnel 2100 may be configured into various geometrical shapes. In some embodiments, wire grid funnel 2100 is fashioned such that it has a generally V or M or W cross-sectional shape. The bottom plate 2102 of the wetted-wire heat exchanger 1100 need not be flat as shown below. This may allow for better drainage of solids.

KEY ADVANTAGES for small pitch: in accordance with disclosed embodiments, decreasing the pitch decreases the amount of flow down each wire (bead velocity) and greatly increases the overall surface area. A potential downside is that the pressure drop across the gas side will be higher. However, it is estimated that the pressure drop would still be less than equivalent packings as described herein.

### Liquid Distribution

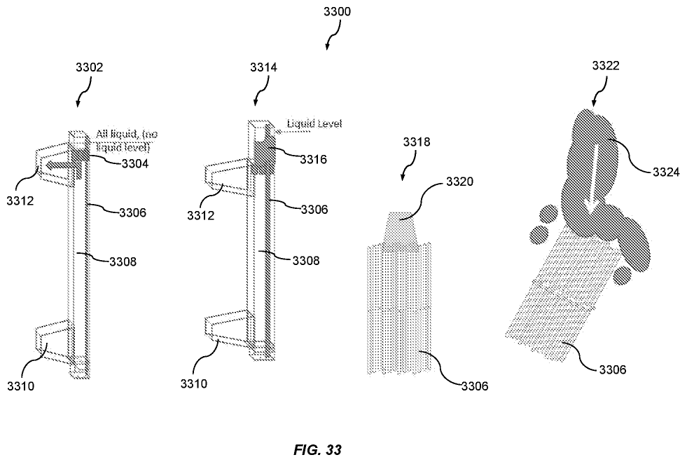

A liquid distribution system is provided to input liquid (such as liquid coolant) to wires of the disclosed wetted-wire heat exchanger. In some embodiments, the wetted-wire heat exchanger may be regarded as a wetted-wire liquid-gas contactor. One of a variety of means may be employed to impart liquid to the wetted wires. For example, turning to FIG. 33, a variety of liquid distribution systems 3300 is illustrated. In some disclosed embodiments, a pump may be configured to the liquid distribution system in order to supply sufficient force to generate liquid at a preferred flow rate or, more specifically, a prescribed flow of liquid beads to the plurality of wires of the wetted-wire heat exchanger. Thus, in a pump driven system 3302, a liquid level supply may be pumped on-demand to a distribution device for providing liquid to wetted wires 3306, for example, in a column design 3308 having a gas inlet 3310 and gas outlet 3312.

In another embodiment, a gravity driven system 3314 may provide a liquid reservoir 3316 which must be designed sufficient enough to supply an appropriate pressure for generating a sufficient liquid flow to wetted wires 3306. Such designs may not be warranted, since a footprint of the liquid reservoir 3316 may be too large and thus yield an impractical design in order to generate the desired liquid flow at an appropriately small pitch.

Alternatively, an exemplary liquid distribution system may utilize a manifold system, as that shown in FIG. 15, may be pump driven. However, it may be difficult to generate a tight enough pitch.

In yet another configuration, a liquid distribution system may employ a spray design 3318, for example, illustrated in FIG. 33 wherein liquid is sprayed 3320 onto wetted wires 3306. Instead of spraying, another liquid distribution system may incorporate a pouring liquid design 3322, wherein liquid is poured 3324, for example, onto a loose packing including wetted wires 3306.

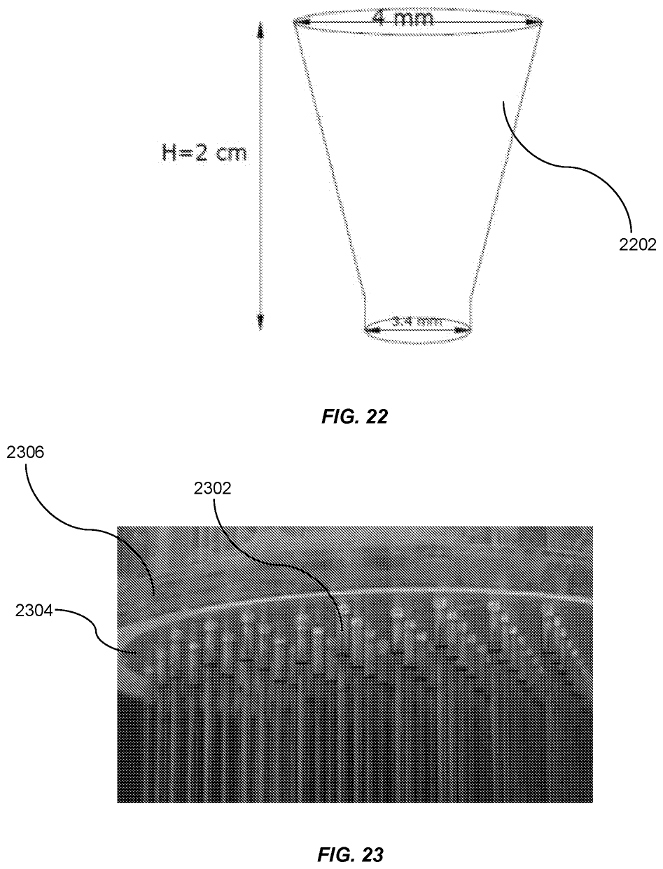

In one configuration, nozzles and nozzle devices may be commissioned to receive the liquid coolant and disperse the same onto one or more wires of the disclosed wetted-wire heat exchanger. Two designs for nozzles have been employed: (1) conical or cylindrical holes 2202 within a plate (FIG. 22). Conical holes can improve the liquid transfer onto the wires (2) cylindrical nozzles 2302 that protrude from a distribution plate 2306 (FIG. 23). This prevents droplets from creeping onto the bottom 2304 of distribution plate 2306. Disclosed embodiments provide that the nozzle length is at least 3 mm in order to avoid liquid gathering, for example, on the bottom of liquid distribution plate 2306.

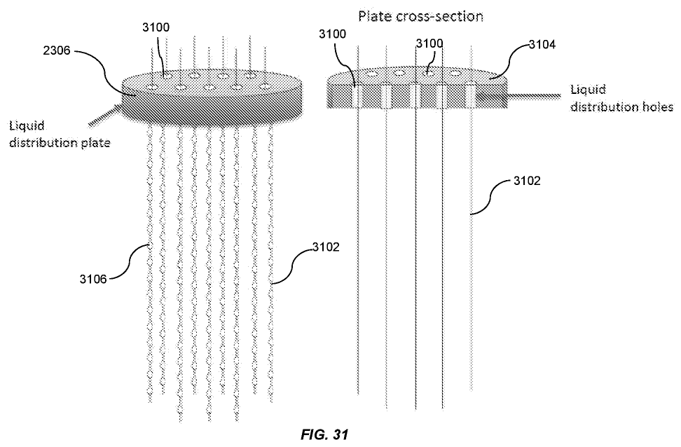

In some embodiments, distribution plate 2306 may serve to provide a surface area for receiving liquid to disburse onto wetted wires. As shown, for example, in FIG. 31 distribution plate 2306 may provide prescribed holes 3100 for receiving wetted wires 3102 therein. In some embodiments, distribution plate 2306 may also serve to space wetted wires 3102 at prescribed distances from one another and at desired locations. The location of holes 3100 may vary at alternate distances and/or a selective patterns. Liquid may be supplied, for example, to a top surface 3104 of distribution plate 2306 and eventually disseminated through holes 3100 onto wetted wires 3102 wherein liquid beads 3106 are formed thereon flowing downwardly along the wetted wires 3102. Distribution of liquid to distribution plate 2306 may occur by forming a liquid pool on top surface 3104. In another example, liquid may be supplied to top surface 3104 by a liquid inlet configured thereto.

In some embodiments, nozzles 2302 (FIG. 23) may be formed in a configuration, such as within holes 3100 of distribution plate 2306. In some configurations, disclosed embodiments may provide a liquid distribution system comprising distribution plate 2306 and one or more nozzles 2302. In some embodiments, nozzles 2302 may be disposed within holes 3100. In order to prevent liquid creep from one hole to another, holes 3100 may be conically shaped. The aforementioned liquid distribution system may further comprise a fluid inlet for receiving a dispensing fluid.

Previous prevailing thought for some previous nozzle configurations was that the nozzles had little effect on the fluid flow down the wire. In fact some convention designs have omitted nozzle dimensions utilized within their experiments. However, disclosed embodiments have determined that nozzles have, at least, a medium influence on the fluid dynamics of the liquid in the column. For example, droplet size of the liquid flowing through the disclosed nozzle may be attended by adjusting a dimension of the nozzle.

The ability of the nozzle for controlling the properties of generated liquid beads contributes to unique features of the disclosed design including: 1) speed of flow—since speed can impact the size of individual liquid beads and distance between each liquid bead generated along the wetted-wires. In some disclosed embodiments, a pump may be configured to the nozzles in order to supply sufficient force to generate liquid at a preferred flow rate or, more specifically, a prescribed flow of liquid beads to the plurality of wires; 2) location of the nozzles: the disclosed nozzles may be placed on top of the wetted-wires; additional sets of nozzles may also be placed at other prescribed locations, for example in the middle of the wetted-wires, in order to change the size of the liquid beads while they are flowing along the wetted-wires. It is readily appreciated additional sets of nozzles may comprise one or more nozzles.

A dimension of the disclosed nozzle may be adjusted to generate a preferred size of the droplet that is generated. Smaller nozzles lead to lower bead velocity, lower bead spacing, and lower bead diameter of droplets, which is generally regarded as good outcomes. Thus, disclosed embodiments prefer an ideal nozzle to be as small as possible while still capable of generating the required flow. Disclosed embodiments observe that even if the back pressure on the liquid is increased, the flow may not increase substantially if the nozzle is small enough.

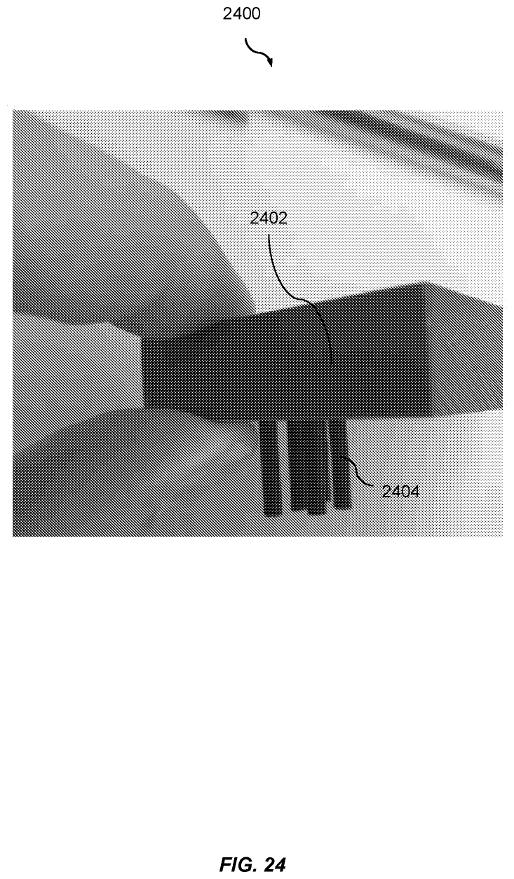

The nozzle diameter is physically constrained as the hole diameter should be less than the pitch and larger than the wire size. Disclosed embodiments may be based upon this parameter(s). For example, it the application is for CO₂ removal, the liquid distributor and nozzles may be made from non-conducting material(s), or otherwise coat or insulate conducting materials to avoid excessive CO₂ desublimation onto the nozzles. The purpose here is to accommodate for metal as a choice of material for a CO₂ desublimation column wherein it is desirable to insulate the nozzles. FIG. 24 illustrates an exemplary nozzle configuration 2400 according to one embodiment of the present disclosure. The disclosed embodiment shows metal nozzles 2402 with electrical wire sleeves 2404 which serve as an insulating barrier. Electrical wire sleeves 2404 may serve to insulate the nozzles, for example, if the material choice is metal. Some disclosed embodiments may refer to the one or more nozzles as a liquid distribution system. The nozzle may be disposed or placed with the disclosed wire concentrically through the nozzle. Thus, respective sets of nozzles may each have a corresponding set of respectively placed wires. Off-centered (eccentric) wires are also feasible but are generally less desirable for modelling reasons.

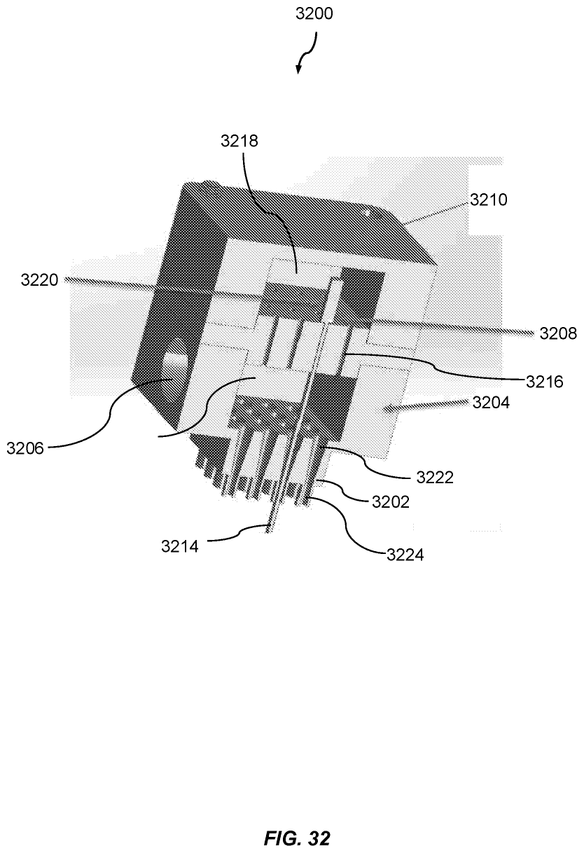

FIG. 32 illustrates a nozzle assembly 3200 according to one embodiment of the present disclosure. Nozzle assembly 3200 may comprise one or more nozzles 3202 formed in a nozzle bank plate 3204. Nozzle bank plate 3204 may include a liquid inlet 3206. A pump (not shown) may be configured to supply and drive liquid to liquid inlet 3206. A top plate 3208 may be formed and, in some embodiments, rest upon nozzle bank plate 3204. Top plate 3208 may be regarded as a distribution or spacer plate. A secondary or top plate 3210 may be formed over top plate 3208. In some disclosed embodiments, a space 3212 may be provided and formed when top plate 3208 is assembled to nozzle bank plate 3204. Space 3212 may be provided to accommodate a volume of liquid disposed through liquid inlet 3206 for providing to one or more wetted wires 3214 disposed through nozzle 3202 and accommodating holes 3216 of top plate 3208.

Another spacer hole 3218 may be formed such as when secondary or top plate 3210 is assembled to and on top of top plate 3208. Spacer hole 3218 may accommodate a segment of wetted wire 3214 which may be crimped to form a crimped bead 3220 to retain wetted wire 3214 in place upon insertion into the disclosed nozzle assembly 3200. Secondary or top plate 3210 may also be employed to prevent/stop any leaking through top plate 3210.

In some embodiments, nozzle 3202 may be designed with a conical portion 3222 which may extend into a generally cylindrical portion 3224. This design may facilitate feeding of the liquid onto the wetted wire 3214 such that not as much pressure is required to provide a feed of liquid to the wires. This embraces and works in tandem with the effectiveness of an employed pump to supply liquid. Thus the pressure required by the pump may be reduced for supply liquid.

Furthermore, the footprint of nozzle assembly 3200 may be reduced from other conventional gravity liquid fed arrangements which may require a large fluid reservoir in order to generate enough pressure to create a desirable liquid flow for supplying the same. Since the disclosed embodiment employs a pump, less pressure is required to create a desirable liquid flow and, hence, space 3212 may be designed with a smaller footprint since a relatively low liquid reservoir is, therefore, required. Thus, the employed nozzle assembly 3200 may be miniaturized as needed.

The physical and chemical properties of the disclosed fluid ejected by the disclosed nozzles onto the wetted-wires may impact the size and shape of the liquid beads, the heat exchanging process and gas capturing capability. An ideal liquid is one which does not freeze at temperatures required to condense or desublimate the pollutant such as isopentane for carbon dioxide.

In some disclosed embodiments, the temperature of the liquid should be low enough to achieve the desumblimation of gas species and allow the removal from the exhaust gas to occur. The temperature of the disclosed liquid should also still allow a liquid bead to move down along the wetted wire at a desirable speed. In a preferred embodiment, the temperature of the disclosed liquid is approximately −110° C. to −135° C.

The fluid flow, droplet size, and droplet flow trajectory may also be controlled by the configuration of the wetted-wires and liquid dispersement/distribution apparatus, as detailed herein.

### Vessels and Gas Circulation Related Components

It is readily appreciated that disclosed embodiments may provide a scale-appropriate system designed to be a vessel as described herein. However, this idea is extendable to a large size scale system such as a flue gas duct. Furthermore, the direction of the flow of flue gas could be counter or in a cross direction with respect to the fluid flowing down the disclosed wires.

In disclosed embodiments, the wetted-wire heat exchanger may be disposed within a gas capture vessel (e.g., see FIG. 3) inside which, gas capturing occurs. In some packed column applications, a column or duct is packed with a packing. It is appreciated that an industrial or domestic application of the disclosed wetted-wire heat exchanger could have no containing vessel. Thus, in accordance with some disclosed embodiments, gas or vapor may be introduced in counter-flow to the liquid (for example, along the wetted-wires), co-flow, or cross-flow, or allowed to convect naturally. Thus, there is no requirement for a vessel. In one example, disclosed embodiments may include a design for a “swamp” evaporative cooler that has water sliding down wetted-wires instead of a more traditional mesh.

In other embodiments, special considerations for the disclosed wetted-wire column may include: a) A square column which may allow for easier assembly and replacement of wires; b) Strengthening accomodations because tension on the wires puts all of the force at the top of the column. Plastic wires may be put under less tension simply by heat treating the wires by raising them temporarily above their glass transition temperature. Structural concerns means that the column diameter could probably not be too large, because the strength of the supporting structure would have to be great enough to hold the wires in tension; c) A configuration utilizing a dense wetted-wire column may be more challenging for the introduction of gas without blowing the liquid off the wires due to stronger local velocities. This means that the inlet and/or outlet should be sufficiently large.

For some disclosed embodiments, a gas inlet direction may be generally perpendicular to the wetted-wire heat exchanger column design—a feature that is unique compared to known prior art configurations. The gas inlet may be placed at the same level or above or below the lower end of the disclosed wetted-wires. This should be near the top and bottom to increase efficiency.

The temperature and pressure of the flue gas entering the vessel may be just above atmospheric pressure and approximately −100° C. In one embodiment, to remove approximately 95% of the CO₂ from a 10% CO₂ laden gas stream, the temperature of the flue gas is cooled to approximately −120° C. to −130° C. Depending upon the viscosity of the cooling liquid, this cooling temperature may even be extended down to approximately −130° C.

### Applications

Special considerations for utilizing the disclosed wetted-wire heat exchanger to condense species from a flue gas (especially CO₂) may include: a) The operating temperatures are entirely dependent on the condensation/desublimation temperature of the species at that pressure. This means that at near ambient pressure for CO₂ the temperature is at least −78.5° C. Typically disclosed embodiments may operate at even lower temperatures in order to capture as much CO₂ as possible; b) Disclosed embodiments for suitable contact liquid fluids may include fluids that transfer heat, are liquid at the desired temperatures, and are reasonably safe/nontoxic. For desublimating CO₂, limited candidates exist. One candidate may include triethyl lead (which is both liquid at room temperature and at −130 C. Other candidates may typically include hydrocarbon liquids; c) disclosed wires may include material that is suitable for low temperatures and do not plasticize in the presence of CO₂. Such materials may include, at least, PI (polyimide), PE (polyethylene), PTFE (polytetrafluoroethylene), and PCTFE (polychlorotrifluoroethylene) and perhaps PVF (polyvinyl fluoride), PVDF (polyvinylidene fluoride), PET (polyethylene terephthalate).

### Deicing and Defouling Techniques

In accordance with disclosed embodiments, a variety of techniques may be employed to ensure that the captured species, such as CO₂, does not clog up the disclosed system: 1) Use of smaller diameter nozzles to ensure high velocity at the outlet; 2) Heating with wires at points of concern, including the distribution plate and nozzles; 3) Employ mechanism(s) to heat the wires and nozzles. Resistive heating is provided as one example of such mechanisms. It is noted that such techniques are reserved only for metallic wires. Thus in one embodiment, metallic wires may be configured to a heating source to provide the resistive heating. The resistive heating is estimated based on the amount of species such as CO₂ to be sublimated back in the time duration of defouling; 4) Anti-frosting coating of the wires. Some disclosed embodiments include polytetrafluoroethylene (PTFE) material; 5) Periodically spraying the disclosed wires with deicing spray. In some disclosed embodiments, the spray may be the same fluid as that flowing along the disclosed wetted-wires, but at higher temperature.

Thus, disclosed embodiments address any need that the desublimating wetted-wire heat exchanger may require including providing addition features in order to prevent fouling or “icing” up over long term use. Accordingly, disclosed embodiments may utilize certain measures for deicing and/or defouling including: making nozzles, wires, nozzle plate(s) and/or anchoring plate out of thermally insulating material; coating wires, or use coated wires; providing selective coating at prescribed locations such as near the nozzle or at the bottom of the column; periodically using a deicing spray of contact fluid to dislodge any accumulations; Periodically warming (1) the wires on which the fluid flows (resistive heating) (2) the nozzles on which the fluid flows (3) the submerged anchoring plate at the bottom of the column.

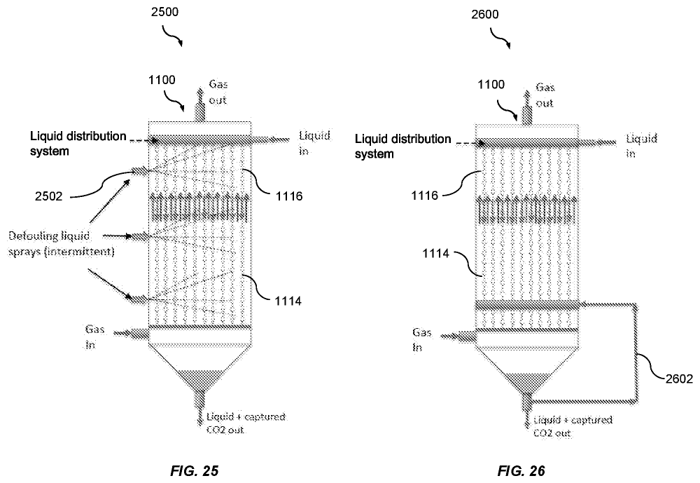

In one disclosed embodiment, the same fluid may utilized to provide deicing and/or defouling. In this instance, the same fluid may be applied but at a higher temperature such as 10° C. to 20° C. warmer than the operating temperature of the wetted-wire heat exchanger environment. Thus in some embodiments, the fluid may be recirculated or, in some cases, a lower concentration of suspended/absorbed captured species such as CO₂ may be applied. FIG. 25 illustrates an exemplary deicing and/or defouling configuration 2500 for wetted-wire heat exchanger configuration 1100 according to one embodiment of the present disclosure. The supplying liquid or other deicing and/or defouling agent may be introduced to the wetted-wire heat exchanger configuration 1100 to perform deicing and/or defouling of the wetted-wire heat exchanger equipment. In some embodiments, the deicing and/or defouling liquid may be introduced such as by a warm liquid that washes off elements and frost intermittently from the wetted-wire heat exchanger. In some disclosed embodiments, a spray apparatus 2502 may be configured to spray deicing and/or defouling liquid to elements of the wetted-wire heat exchanger including, for example, wetted-wires 1114. In some embodiments, the deicing and/or defouling liquid may be periodically applied, for example. It is readily appreciated that the spray may be applied to other areas of wetted-wire heat exchanger configuration 1100 to address deicing and/or defouling as needed

Alternatively, FIG. 26 illustrates another exemplary deicing and/or defouling configuration 2600 for a wetted-wire heat exchanger configuration 1100 according to one embodiment of the present disclosure. The supplying liquid and captured species (such as CO₂) may be reintroduced (recirculated) 2602 back to elements of the wetted-wire heat exchanger 1100 such that the increased volumetric flow of the lower end of the wire destabilizes and washes off the wire flows, therefore avoiding ice accumulation. Accordingly, as shown in FIG. 26, the supplying liquid and captured species (such as CO₂) is reintroduced (recirculated) 2602 to the wetted-wires 1114 of the wetted-wire heat exchanger. It is readily appreciated that the spray may be applied to other areas of wetted-wire heat exchanger configuration 1100 to address deicing and/or defouling as needed.

### Additional Advantages and Other Applications

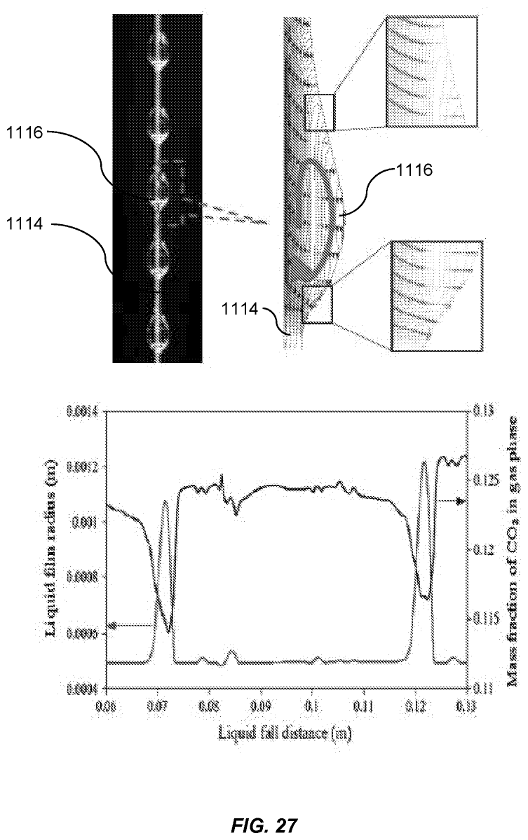

Design characteristics of the disclosed wetted-wire heat exchanger provide unique advantages. One such advantage includes an improved mixing due to recirculating flow in the bead produced by the disclosed system. FIG. 27 depicts a vortex structure inside a typical bead 1114 along wire 1114 with details of the front and back according to disclosed embodiments. Vectors represent film velocity relative to a reference frame which moves at 0.2 m/s. f_{far}=17 Hz, A=10%. The maximum relative velocity downward is 0.05 m/s.

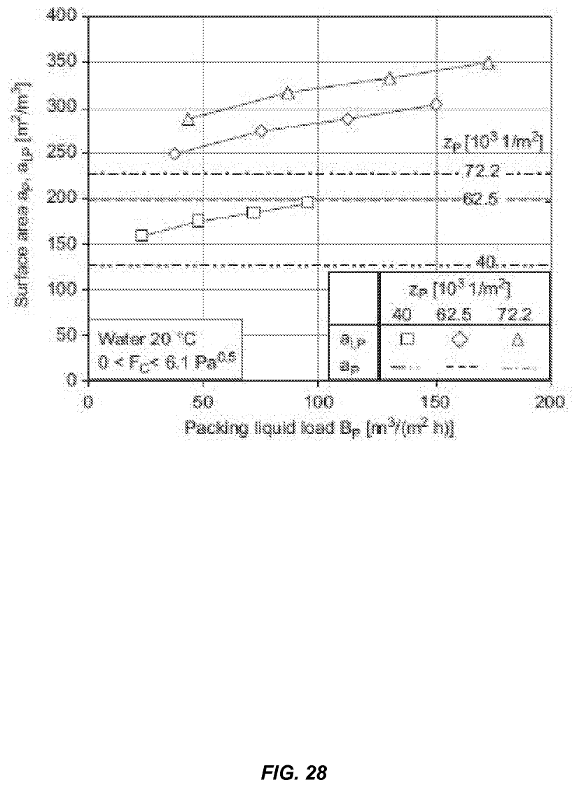

FIG. 28 graphically illustrates increased surface are density according to one embodiment of the present disclosure. For a spray column with droplets 1-3 mm, the calculated area density is 30-4 m²/m³ resp. for the same flow range shown in FIG. 28. Thus, an order of magnitude higher area can be achieved.

Other advantages provided by the disclosed wetted-wire column's applicability depends on one or more of other unique properties including: 1) Low liquid to gas ratio: A process that uses a very low liquid to gas ratio may choose to use the disclosed wetted-wire column, because it is capable of operating at lower liquid/gas ratios. 2) Low pressure drop desired: Vacuum distillation is a set of processes that require low-pressure drop packing. Grid or lattice structures are often used for this application. Any additional pressure drop in the column adds to the amount at which the vacuum operates. Distillation requires liquid to be introduced at the middle of a tower. This could be done by introducing a secondary nozzle plate that collects liquid from the wires and redistributes the liquid. A low pressure drop is often desired in processes with large gas quantities such as dehumidification and humidification, or where blower costs would be significant such as scrubbing of flue gasses; 3) Mini-reactor or pseudomicrofluidics applications: The distribution of the disclosed liquid across the tower is nearly perfect, because the droplets are all roughly uniform in size. This means that each disclosed droplet functions as a mini reactor. Disclosed embodiments are applicable where the residence time of a liquid within a gas/liquid reaction need to be very accurately controlled. This could be applicable in the polymers industry where residence time changes polydispersity. Most applications that require a very specific residence time are done in a plug flow reactor. However, if it is desired to supply gas to the reactor through bubbling, the aforementioned configuration may not perform well, because it breaks up the plug flow that would occur in a plug flow reactor. The disclosed embodiments may provide a viable solution to address this problem. This, at least in part, is due to the disclosed wetted-wire column having a very good liquid distribution. A wetted-wire column has a very specific residence time, because each bead/droplet takes a certain amount of time to go from the top of the tower to the bottom. Whereas, in a plug flow reactor, this is not the case. Liquid molecules flowing into the reactor may stay in the reactor for an average amount of time—some stay longer and some stay shorter. 4) Substitute for trickle bed reactors: Trickle bed reactors are similar to liquid/gas packed columns. They currently face the problem of complex hydrodynamics due to the multiphase flow. The disclosed wetted-wire column may be implemented, because the hydrodynamics are more simple to describe. In this case, disclosed embodiments may address challenges for depositing the catalyst on or in the wires or within the liquid itself; 5) Potentially higher viscosity systems: Packed columns are known for not handling higher viscosity liquids very well. The disclosed wetted-wire column seeks to work with higher viscosity liquids and may include a new class of higher viscosity liquids including new or different types of amines or amine solutions for carbon capture (different from the CCC process). 6) Better solids handling: Packed columns are notorious for poor solids handling. In contrast, the disclosed wetted-wire column does not have any “dead” areas or film areas with little or no liquid flow compared to others, so the disclosed wetted-wire column is likely to be much less prone to solids accumulation. 7) In disclosed embodiments, the flow pattern over a wire can be more controlled than in a spray tower where droplets can break depending on the relative velocity (Weber number). 8) Disclosed embodiments provide further control of the coolant temperature by conduction through the wire (heat dissipation from the liquid).

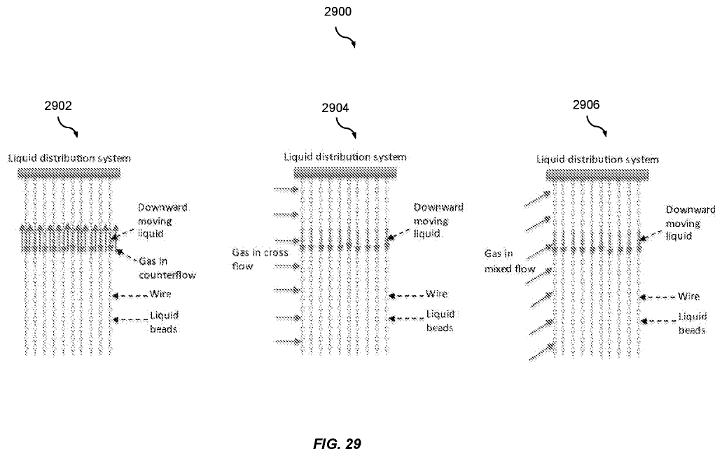

FIG. 29 illustrates various applied scenarios for different conditions of the disclosed wetted-wire system 2900. In a first scenario 2902, liquid beads are illustrated along the wire(s) as the liquid flow is depicted in a downward flow along the wire(s). The gas is shown in a counter-flow to the liquid flow along the wire(s). In another scenario 2904, liquid beads are illustrated along the wire(s) as the liquid flow is depicted in a downward flow along the wire(s). The gas is shown in a cross-flow to the liquid flow along the wire(s). In yet another scenario 2906, liquid beads are illustrated along the wire(s) as the liquid flow is depicted in a downward flow along the wire(s). The gas is shown in a mixed flow to the liquid flow along the wire(s).

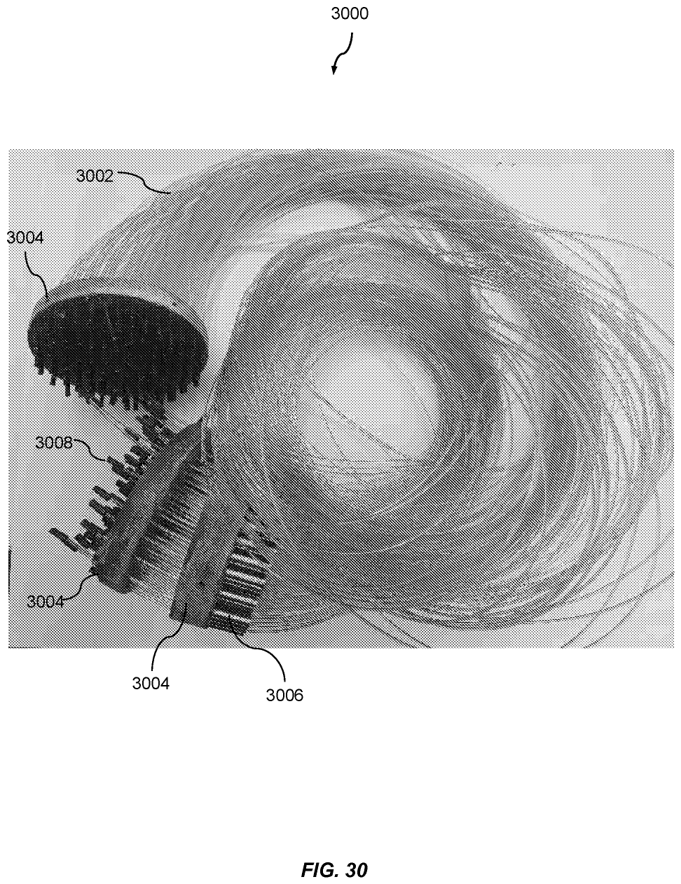

FIG. 30 illustrates an embodiment of the wetter wire heat exchanger 3000. A plurality of wetted-wires 3002 are assembled between distribution plates 3004. Respective nozzles 3006 provide fluid flow to respective wetted-wires 3002. In one embodiment, ends of the wetted-wires 3002 are retained and secured to distribution plates 3004 via crimping beads 3008. Embodiments may provide a semi-stretchable wire as the employed wetted-wires 3002 in wetter wire heat exchanger 3000. If a semi-stretchable wire is used then the wire can be tensioned and released into place after both ends are crimped with a crimping bead.

Some disclosed embodiments may provide the wetter wire heat exchanger 3000 as a stand-alone assembly—i.e., without walls. Thus in a final assembly wire heat exchanger 3000 may be in a stand-alone configuration. In other embodiments, wetter wire heat exchanger 3000 may be assembled in a configuration wherein it is encapsulated, such as, within a vessel. Accordingly, in a final assembly, wetter wire heat exchanger 3000 may assembled within a vessel.

### Water Removal System

In any disclosed low-temperature carbon capture scheme, the water must be dried from the flue gas. Drying and precooling the gas may be accomplished in one step by using the disclosed wetted-wire heat exchanger and a desiccant.

Disclosed embodiments may provide a water removal system structurally similar to the disclosed gas capture and wetted-wire heat exchanger system. However, one notable exception is that, for disclosed embodiments, the fluid flowing along the wetted-wires may not be water. The fluid may be a liquid desiccant, such as ethanol or propylene glycol, methanol, propanol, butanol, and other alcohols.

In some embodiments, two wetted-wire heat exchangers are provided. One wetted-wire heat exchanger may be reserved exclusively for water removal, and the other wetted-wire heat exchanger may be utilized exclusively for species removal from the exhaust stream. It is noted that both of the aforementioned wetted-wire heat exchangers may operate by condensing a species by contact with a lower temperature contact liquid in a wetted-wire heat exchanger. While two wetted-wire heat exchangers have been described in an arrangement, it is readily appreciated that more wetted-wire heat exchangers may be utilized in order to accomplish additional water removal or capturing of species from the exhaust stream as needed.

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

### REFERENCES

The following references are referred to above and are incorporated herein by reference:
1. Zeng, Sadeghpour, and Ju., “Thermohydraulic characteristics of a multi-string direct-contact heat exchanger,” International Journal Heat and Mass Transfer 123, 536-544 (2018).
2. Zeng, Sadeghpour, Warrier, and Ju., “Experimental study of heat transfer between thin ligquid films flowing down vertical string in the Rayleigh-Plateau instability regime and a counterflowing gas stream,” International Journal Heat and Mass Transfer 108, 830-840 (2017).
3. Zeng, Sadeghpour, and Ju., “A highly effective multi-string humidifier with a low gas stream pressure drop for deaslination,” Desalination 449, 92-100 (2019).
4. Zeng, Warrier, and Ju., “Study of the fluid dynamics of thin liquid films flowing down a vertical string with counterflow of gas,” Proceedings of the ASME 2015 International Mechanical Engineering Congress and Exposition IMECE2015-53132, 1-8 (2015).
5. Sadeghpour, Ju and Bertozzi., “Modeling film flows down fibre influenced by nozzle geometery,” Journal of Fluid Mechanics arXiv:2007.09582v1, 1-11 (2020).
6. Zeng, Sadeghpour, and Ju., “Experimental study of heat transfer and pressure drop in a multistring based direct contact heat exchanger,” International Heat Transfer Conference IHTC16-22112, 7541-7548 (2018).
7. Zeng, Sadeghpour, and Ju., “Effects of nozzle geometery on the fluid dynamics of thin liquid films flowing down vertical strings in the Rayleigh-Pateau Regime,” American Chemical Society 33, 6292-6299 (2017).
8. Zeng, Z. “Interfacial heat and mass transfer of liquid films flowing down strings against counterflowing gas streams,” UCLA. ProQuest ID: Zeng_ucla_0031D_17564. Merritt ID: ark:/13030/m5nw4gvr. Retrieved from https://escholarship.org/uc/item/9d35150m (2019).
9. Migita, Soga and Mori., “Gas absorption in a Wetted-Wire Column,” American Institue of Chemical Engineers Vol. 51, No. 8, 2190-2198 (2005).
10. Uchiyama, Migita, Ohmura and Mori., “Gas absorption into ‘string-of-beads’ liquid flow with chemical reaction: application to carbon dioxide separation,” International Journal Heat and Mass Transfer 46, 457-468 (2003).
11. Chinju, Uchiyama, and Mori., “‘String-of-beads’ flow of liquids on vertical wires for gas absorption,” American Institue of Chemical Engineers Journal Vol. 46, No. 5, 937-945 (2000).
12. Hattori, Ishikawa, and Mori., “Strings of liquid beads for gas-liquid contact operations,” American Institue of Chemical Engineers Journal Vol. 40, No. 12, 1983-1992 (1994).
13. Nozaki, Kaji and Mori., “Heat transfer to a liquid flowing down vertical wires hanging in a hot gas string: an experimental study of new means of thermal energy recovery,” 11^{th} IHTC, 63-68 (1998).
14. Hosseini, Alizadeh, Fatehifar and Alizadehdakhel., “Simulation of gas absorption into string-of-beads liquid flow with chemical reaction,” Heat Mass Transfer 50, 1393-1403 (2014).
15. Galledari, Alizadeh, Fatehifar and Soroush., “Simulation of carbon dioxide absorption by monoethanolamine solution in wetted-wire column,” Chemical Engineering and Processing 102, 59-69 (2016).
16. Pakdehi and Taheri., “Separation of hydrazine from air by wetted wire column,” Chemical Engineering Technol. 33, No. 10 1687-1694 (2010).
17. Taheri, Pakdehi, and Rezaei., “Natural gas sweetening by wetted-wire column,” World Academy of Science, Engineering Technol. 47, 754-757 (2010).
18. Grunig, Lyagin, Horn, Skale and Kraume., “Mass transfer characteristics of liquid films flowing down a vertical wire in a counter current gas flow,” Chemical Engineering Science 69, 329-339 (2012).
19. Wehinger, Peeters, Muzaferij a, Eppinger and Kraume, “Numerical simulation of vertical liquid-film wave dynamics,” Chemical Engineering Science 104, 934-944 (2013).
20. Grunig and Kraume., “Liqid flow on a vertical wire in a countercurrent gas flow,” Chemical Engineering Journal 164, 121-131 (2010).
21. Cong, Zhao, X. Li, H. Li, and Gao., “Liquid-bridge flow in the channel of helical string and its application to gas-liquid contacting process,” American Institue of Chemical Engineers Journal Vol. 64, No. 9, 3360-3368 (2018).
22. Grunig, Kim and Kraume., “Liquid film flow on structured wires: fluid dynamics and gas-side mass transfer,” American Institue of Chemical Engineers Journal Vol. 59, No. 1, 295-302 (2013).
23. Grunig, and Kraume., “Annular liquid films on a vertical wire with counter current gas flow—experimental investigations,” Chemical Engineering Transactions Vol. 17, 621-626 (2009).
24. Gabbard, Chase Tyler, “Asymmetric Instability of Thin-Film Flow on a Fiber,” All Theses. 3279. https://tigerprints.clemson.edu/all_these/3279 (2020)
25. Gabbard and Bostwick., “Scaling analysis of the Plateau-Rayleigh istability in thin film flow down a fiber,” Experiments in Fluids 62:141, 1-11 (2021).
26. Gabbard and Bostwick., “Asymmetric instability in thin-film flow down a fiber,” Phys. Rev. Fluids Vol. 6, No. 3, 034005-1-034005-12 (2021).
27. Moon, Jeong and Addad., “Design of air-cooled waste heat removal system with string type direct contact heat exchanger and investigation of oil film instability,” Nuclear Engineering and Technology 52, 734-741 (2020).
28. Moon, Addad and Jeong., “Study on various direct contact heat exchanger types for dry cooled waste heat removal system and SMRs,” Transactions of the Korean Nuclear Societ Spring Meeting Jeju, Korea, May 17-18, 2018.
29. Mohamed., “Performance of a new packing element for packed column using air-water system,” Disseration BS fullfillment for Universiti Teknologi Petronas, (2015).
30. Sapree., “Development of a new packing element for packed bed absorber,” Disseration BS fullfillment for Universiti Teknologi Petronas, (2014).
31. Xie, Liu, Wang, and Chen., “Investiation of flow dynamics of thin viscous films down differently shaped fibers,” Appl Phys. Lett. 119, 201601 (2021); https://doi.org/10.1063/5.0069189
32. Sedighi, Zeng, Sadeghpour, Ji, Ju and B ertozzi., “Capillary-driven rise of well-wetting liquid on the outer surface of cylindrical nozzles,” American Chemical Society 37, 10413-10423 (2021); https://doi.org/10.1021/acs.langmuir.1c01096

All documents, patents, journal articles and other materials cited in the present application are incorporated herein by reference.

While the present disclosure has been disclosed with references to certain embodiments, numerous modification, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

1. A wetted-wire liquid-gas contactor device comprising:
a plurality of wires;
a first support structure configured to retain the plurality of wires; and
a liquid distribution system for receiving and distributing a liquid to the plurality of wires,
wherein the diameter of each of the plurality of wires is approximately 2 mm or less,
wherein a pitch of the plurality of wires is less than 4.0 mm.

2. (canceled)

3. The device of claim 1, wherein the liquid is a coolant.

4. The device of claim 1, wherein the plurality of wires are configured parallel or nearly parallel to one another.

5. The device of claim 1, wherein each of the plurality of wires is retained at one end in a fixed position by the first support.

6. The device of claim 5, wherein the plurality of wires are suspended from one end.

7. The device of claim 5, further comprising:
a second support structure configured to retain another end of the plurality of wires in a fixed position.

8. The device of claim 7, wherein the plurality of wires are configured under tension in a final assembly.

9. The device of claim 7, wherein the plurality of wires are configured parallel or nearly parallel to one another.

10. The device of claim 7, wherein the plurality of wires are configured at an incline angle from a vertical direction.

11. (canceled)

12. The device of claim 1, wherein the plurality of wires are smooth.

13. (canceled)

14. The device of claim 1, wherein one or more of the plurality of wires are formed as converging or diverging wires.

15. The device of claim 1, wherein the wetted-wire liquid-gas contactor device is formed as a stand-alone configuration in a final assembly.

16. The device of claim 1, wherein the wetted-wire liquid-gas contactor device is formed within a vessel in a final assembly.

17. (canceled)

18. The device of claim 16, wherein a gas inlet is configured to the vessel for receiving an incoming gas for capturing a species therefrom.

19. The device of claim 18, wherein a gas inlet direction is configured generally perpendicular to the wetted-wire liquid-gas contactor device.

20. The device of claim 16, wherein an outlet is configured to the vessel for removing liquid and the captured species from the incoming gas.

21. The device of claim 18, wherein an end of the plurality of wires is disposed above the gas inlet.

22. The device of claim 18, wherein an end of the plurality of wires is disposed below the gas inlet.

23. The device of claim 1, wherein the plurality of wires is selected from materials comprising one of: PI (polyimide), PE (polyethylene), PTFE (polytetrafluoroethylene), and PCTFE (polychlorotrifluoroethylene), PVF (polyvinyl fluoride), PVDF (polyvinylidene fluoride), and PET (polyethylene terephthalate), nylon, metals, any fibrous material, cotton, cellulosic, plastic, and other synthetics.

24. A wetted-wire liquid-gas contactor device comprising:
a plurality of wires;
a first support structure configured to retain the plurality of wires at one end in a fixed position;
a second support structure configured to retain another end of the plurality of wires in a fixed position; and
a liquid distribution system for receiving and distributing a liquid to the plurality of wires,
wherein the diameter of each of the plurality of wires is approximately 2 mm or less,
wherein a pitch of the plurality of wires is less than 4.0 mm.

25. A gas capture system for capturing a species in exhaust gas comprising:
a pollutant source configured for providing an exhaust gas stream to the gas capture system;
a wetted-wire liquid-gas contactor configured to receive exhaust gas from the exhaust gas stream; and
a contact liquid distribution system configured for receiving and distributing contact liquid for removing pollutants by cooling the exhaust gas at the wetted-wire liquid-gas contactor by condensation or desublimation,
wherein the wetted-wire liquid-gas contactor comprises:
a plurality of wires; and
a first support structure configured to retain the plurality of wires,
wherein the diameter of the plurality of wires is approximately 2 mm or less.
